(19) United States
(12) Patent Application Publication
(10) Pub. No.: US 2006/0107123 A1
(43) Pub. Date: May 18, 2006

(54) Processor and development supporting apparatus

(75) Inventors: Atsushi Okamoto, Takatsuki-shi (JP); Tsutomu Mikami, Kyoto-shi (JP); Atsushi Ubukata, Yawata-shi (JP)

Correspondence Address: PANASONIC PATENT CENTER;c/o MCDERMOTT WILL & EMERY LLP, 600 13TH STREET, NW, WASHINGTON, DC, 20005-3096, US

(73) Assignee: Matsushita Electric Industrial Co., Ltd.

(21) Appl. No.: 11/246,364

(22) Filed: Oct. 11, 2005

(30) Foreign Application Priority Data
Oct. 25, 2004 (JP) P2004-309611

(51) Int. Cl. G06F 11/00

(52) U.S. Cl. 714/38

(57) ABSTRACT

A processor includes a statically scheduled command removal unit which removes a statically scheduled command upon receiving a command issuing signal, a command execution condition establishing signal, and a statically scheduled execution determination signal that indicates a command for which execution is determined in advance, an encoding unit which encodes an execution history for commands, statically scheduled commands excluded, upon receiving a command execution condition establishing signal, for which a statically scheduled command is excluded, and a command issue signal, for which a statically scheduled command is excluded, all of which are obtained by the statically scheduled command removal unit, and a data packet generation unit which generates a trace packet upon receiving encoded data obtained by the encoding unit. This trace information is processed by a development supporting apparatus.

This application is based on Japanese Patent Application No. 2004-309611, which is incorporated herein by reference.

### BACKGROUND OF THE INVENTION

1. Field of the Invention

The present invention relates to an information processing apparatus (a processor), the program execution state of which can be externally observed, and a development supporting apparatus that employs this processor.

2. Description of the Related Art

A trace information output function is a function whereby the program execution state of a processor is output to a debugger operating on an external host computer. When a system employing the processor detects the performance of a specific abnormal operation by a program, a system developer can examine, from the abnormality detection point, accumulated trace information, and can trace the execution history of the program and identify the cause of the abnormal operation.

However, since for an apparatus used to provide development support, the number of pins that can be added for the output of trace information is limited, as a consequence, the bandwidth available for the output to a processor of such information is likewise limited. And further, since the memory capacity available for the storage of trace information is also limited, to demonstrate the maximum effects that can be obtained while using the available limited trace output bandwidth and trace memory capacity, compression of the trace information is required.

Furthermore, as the speed of a CPU is increased, to avoid execution disturbances that may affect the use of a pipeline, a system is frequently employed whereby, during a process for the execution of a conditional execution command, a command is issued, and the execution (commitment) of the command that is accompanied by the updating of a register is determined depending on whether the added condition has been established.

A related example method, for the output of trace information by a CPU, is an execution flag trace method for obtaining trace information by employing an execution condition flag (see, for example, ARM Limited, “ARM IHI 00141, Embedded Trace Macrocell Architecture Specification”).

In an execution flag tracing process, information provided for a chip concerning an execution condition is externally output for the execution of each command. Based on the trace information output, an external debugger analyzes the execution states of commands while comparing them with those in a source program, so that an execution history can be prepared and retrieved.

A processor and execution history retrieval software on this principle will now be described while referring to drawings. FIG. 29 is a block diagram showing the configuration of a related processor that outputs trace information. In FIG. 29, the processor includes a CPU 300, an encoding circuit 310 and a packet generation circuit 320.

The CPU 300 outputs, to the encoding circuit 310, a command issue signal 301, a command execution condition establishing signal 302 and an operand detection signal 303, and outputs operant data 304 to the packet generation circuit 320. When a command execution condition has been established, the command issue signal 301 and the command execution condition establishing signal 302 are set to “1”, and when a command execution condition has not been established, the command issue signal 301 is set to “1” and the execution condition establishing signal 302 is set to “0”. When operand information is generated, the operand detection signal 303 is set to “1”.

The encoding circuit 310 receives the command issue signal 301, the command execution condition establishing signal 302 and the operand detection signal 303, and outputs, to the packet generation circuit 320, an encoded data output select signal 311, encoded data 312 and a bit count value 313 for the encoded data 312. The details of the encoding circuit 310 will be described later.

The packet generation circuit 320 receives the encoded data output select signal 311 the encoded data 312, the bit count value 313, the operand detection signal 303 and the operand data 304, and outputs a trace packet output state signal 131 to a trace state output terminal 150, and a trace packet 132 to a trace data output terminal 151. The details of the packet generation circuit 320 will be described later.

FIG. 30 is a block diagram showing the internal arrangement of the encoding circuit 310. In FIG. 30, the encoding circuit 310 includes a counter 314, a shift register 315 and comparators 316 and 317.

The shift register 315 employs the command issue signal 301 as a shift enable signal and the command execution condition establishing signal 302 as a shift-in signal, and generates the encoded data 312 that means a flag string indicating the command execution state. The counter 314 employs the command issue signal 301 as a count-enable signal, and generates the bit count value 31.3 for the encoded data 312.

The comparator 316 compares the bit count value 313 with a value set in the comparator 316, and when the two values match, sets a count match signal 318 to “1”. The comparator 317 compares the bit count value 313 with “0”, and when the bit count value 313 is not “0”, sets a count match signal 319 to “1”. The encoded data output select signal 311 is generated by employing a logical sum for the logical product of the count match signal 318 and the command issue signal 301, and the logical product of the count match signal 319 and the operand detection signal 303.

FIG. 31 is a block diagram showing the internal arrangement of the packet generation circuit 320. In FIG. 31, the packet generation circuit 320 includes an effective bit count/bit count generation circuit 323, a packet ID storage circuit 326, a trace data assembling circuit 328, an FIFO writing control circuit 329 and an FIFO queue 333.

The effective bit count/bit count generation circuit 323 generates an effective bit count 324 consonant with the least significant three bits of the bit count value 313, and an effective byte count 325 consonant with a value equal to or greater than the least significant fourth bit of the bit count value 313. The packet ID storage circuit 326 stores a packet ID 327, which is a constant.

The trace data assembling circuit 328 receives the packet ID 327, the encoded data 312, the effective bit count 324, the encoded data output select signal 311, the operand detection signal 303 and the operand data 304. When the encoded data output select signal 311 indicates “1”, the trace data assembling circuit 328 generates a data string consisting of the packet ID 327, the effective bit count 324 and the encoded data 312, divides this data string into bytes, and outputs the data byte by byte as trace data 331.

When the operand detection signal 303 indicates “1”, the trace data assembling circuit 328 generates a data string consisting of the packet ID 327 and the operand data 304, divides this data string into bytes, and outputs the data byte by byte as trace data 331.

Further, when outputting the first effective data as the trace data 331, the trace data assembling circuit 328 also outputs a trace data output stage signal 330 of “1”. When outputting the second and following trace data, the trace data output state signal 330 is set to “0”.

The FIFO writing control circuit 329 receives the effective byte count 325, the encoded data output select signal 311 and the operand detection signal 303, and generates a write enable signal 332 to be transmitted to the FIFO queue 333 in order to handle the trace data output state signal 330 and the trace data 331.

The FIFO queue 333 receives the trace data state signal 330, the trace data 331 and the write enable signal 332, shifts data received in synchronization with a reference clock for trace data output, and outputs a trace packet output state signal 131 and a trace packet 132 in the order in which they were input.

FIG. 5 is a diagram showing packet IDs stored in the packet ID storage circuit 326. In FIG. 5, “Packet ID”, “Message Name” and “Mnemonic” are entered for the individual packet IDs.

When “Packet ID” is “0b00”, “Message Name” is “Idle” and “Mnemonic” is “IDLE”. When “Packet ID” is “0b01”, “Message Name” is “Taken Flag” and “Mnemonic” is “TF”. When “Packet IF” is “0b10”, “Message Name” is “Taken Count” and “Mnemonic” is “TC” When “Packet ID” is “0b11”, “Message Name” is “Operand Data” and “Mnemonic” is “OD”.

“Taken Flag” and “Taken Count” used as the “Message Name” entries will now be explained. “Taken Flag” is a flag string representing a command execution state (a bit string indicating “1” when a command execution condition is established after a command is issued or indicating “0” when a command execution condition is not established after a command is issued) that is output as encoded data by encoding means upon receiving the command issue signal 301 and the command execution condition establishing signal 302.

“Taken Count” is the number of times command execution conditions were established (the number of times command execution conditions establishing signal 302=“1” were continued when commands were issued) that is output as encoded data by encoding means upon receiving the command issue signal 301 and the command execution condition establishing signal 302.

An explanation will now be given for an example encoding of “Taken Flag”. FIG. 6 is a diagram showing the format of a trace packet to be output by the FIFO queue 333 when the encoded data 312 are output as trace data.

In FIG. 6, “clock” denotes a reference clock for the trace data output. TRCDAT[7:0] denotes the format of the trace packet 132, output to the trace data output terminal 151, and includes: Taken Flag[31:0], indicating the value of the encoded data 312; NV[2:0], indicating the value of the effective bit count 324 of the encoded data 312; and TF, indicating the value of a packet ID. TRCSYNC indicates the value of the trace packet output state signal 131 to be output to the trace state output terminal 150. And “comments” denotes a packet transfer state.

As shown in FIG. 6, in synchronization with “clock”, TF, NV[2:0] and Taken Flag[31:0] are sequentially output byte by byte as trace data.

FIG. 7 is a diagram showing the format of a trace packet output by the FIFO queue 333 when the operand data 304 are output as trace data.

In FIG. 7, “clock” denotes a reference clock for trace data output and TRCDAT[7:0] denotes the format of the trace packet 132, output to the trace data output terminal 151, and includes: Operand Data[31:0], indicating the value of the operand data 304; and OD, indicating the value of a packet ID.

FIG. 8 is a block diagram showing the configuration of a development supporting apparatus. In FIG. 8, the development supporting apparatus comprises: a processor 1, a trace information accumulation device 2 and a host computer 3.

The processor 1 outputs the trace packet output state signal 131 and the trace packet 132 to the trace information accumulation device 2. The trace information accumulation device 2 receives the trace packet output state signal 131 and the trace packet 132, and employs a trace memory controller 160 to control a trace memory control signal 163 and trace memory write data 164 and to store the signal and the data as trace information in a trace memory 165.

The trace information accumulation device 2 also receives a trace memory read request signal 161 from the host computer 3, and employs the trace memory controller 160 to access the trace memory 165 and to transmit trace memory output data 162 to the host computer 3.

While referring to FIGS. 32 to 36, an explanation will now be given for the processing whereby the host computer 3 obtains trace data from the processor with this arrangement and retrieves an execution history. In this processing, assume that the comparison value used for the comparator 316 in FIG. 30 is “16”.

FIG. 32 is a diagram showing example commands for a sample program, and “command addresses”, an “assembler program” and an “execution order” are shown. Commands from “command 1”, in the “execution order” for (1), to “command 16”, in the “execution order” for (14), are executed in order. In this example, it is assumed that “command 8” and “command 10” are those that are not executed.

In FIG. 32, when commands are executed beginning at address 0×50000000, the command issue signal 301 is asserted each time the CPU issues a command, and at the same time the command issue signal 301 is output, a condition that provides an established bit of “1” or an unestablished bit of “0” is output as the command execution condition establishing signal 302. When, for example, 16 commands are issued the result “1111111010111111” is output.

Upon receiving this result, the encoded data 312 output by the shift register 315 of the encoding circuit 310 is changed so that it also is “1111111010111111”. Further, the bit count value 313 of the counter 314 is incremented to “0×10” while the value of the command issue signal 301 is regarded as a count enable signal. When the bit count value 313 reaches “0×10”, the count match signal 318 is set to “1”, as is the encoded data output select signal 311.

Then, the effective bit count/byte count generation circuit 323 of the packet generation circuit 320 outputs “0b101” as the effective bit count 324, consonant with the least significant three bits (the bit count value “0×10”+the bit count “0×3”, for NV, +the bit count “0×2”, for a packet ID), and outputs “0b10” as the effective byte count 325, consonant with the value equal to or greater than the least significant fourth bit.

Upon receiving the bit count 324, and beginning with the least significant bit, the trace data assembling circuit 328 of the packet generation circuit 320 arranges packet ID=value “0b01”, for TF, NV=value “0b101”, for the effective bit count 324, and Taken Flag=“0b1111111010111111”.

After the value of the encoded data output select signal 311 has been changed to “1”, the FIFO writing control circuit 329, in synchronization with the reference clock for trace output sets the FIFO write enable signal 332 to “1” three times (=the value of the effective byte count 325+1).

Upon receiving the write enable signal 332=“1”, data generated by the trace data assembling circuit 328 are output byte by byte to the FIFO queue 333 three times. At the same time the first type of the data is output, a trace data output state signal 330 of “1” is also output.

The FIFO 333 receives the trace data and the trace data output state signal 330, and outputs the trace packet 132 and the trace packet output state signal 131. FIG. 33 is a diagram showing a trace packet when the sample program shown in FIG. 32 is executed.

The host computer 3 receives a packet shown in FIG. 33, and obtains packet ID=TF from TRCDAT[1:0] and NV=5 from TRCDAT[4:2]. Since NV=5, encoded data FLAG=0b1111111010111111 is obtained. FIG. 34 is a diagram showing trace information that the host computer 3 has obtained from the processor 1 in this manner.

An explanation will now be given for the processing whereby the host computer 3 retrieves execution history based on the sample program in FIG. 32 and the trace information in FIG. 34. FIG. 35 is a flowchart showing an algorithm used by the host computer 3 to retrieve the execution history.

In FIG. 35, at step 4000, IP is designated as address 0×50000000, TP is designated as address 0×0, and ETP is designated as address 0×1. Since TP≠ETP, program control skips step 4001 and advances to step 4002 and since a trace message is TF, moves to steps 4004 and 4005. Further, since the value of a flag is “1”, command 1 is displayed at address 0×50000000 and IP is incremented to address 0×50000000.

Since effective flags are remained, then command 2 is displayed at address 0×50000004 and IP is incremented to address 0×50000008. Similarly, command 3, command 4, command 5, command 6 and command 7 are respectively displayed at addresses 0×50000008, 0×5000000c, 0×50000010, 0×50000014 and 0×50000018. Since the value of a flag that corresponds to the next command 8 is “0”, address 0×50000020, for the next command 9, is set for IP, and since the value of the succeeding flag is “1”, command 9 is displayed at address 0×50000020, and IP is incremented to address 0×50000024.

Furthermore, since the value of a flag that corresponds to the next command 10 is “0”, address 0×50000028, for the following command 11, is set for IP, and since the value of the succeeding flag is “1”, command 11 is displayed at address 0×50000028. Similarly, command 12, command 13, command 14 and command 15 are respectively displayed at addresses 0×5000002c, 0×50000030, 0×50000034 and 0×50000038. When the process for the number of effective flags is completed, TP is set at address 0×1 and program control returns to step 4001. Since it is determined at step S4001 that TP=ETP has been established, the execution history retrieval processing is terminated.

FIG. 36 is a diagram showing the execution history obtained through this processing. In FIG. 36, “trace memory address”, “trace message”, “trace packet”, “addresses” and “retrieved execution history” are shown, and it can be confirmed that the sample program shown in FIG. 32 can be retrieved.

For this related technique, however, a problem exists in that the compression rate for trace information is low.

Specifically, according to the related technique, the condition for providing an established/unestablished bit for a conditioned execution command must be output each time a command is executed, and even when encoding means is obtained, basic information is constantly generated for each bit, for each command. In addition, the number of commands issued in one cycle by a high-performance CPU is increased, e.g., three or four commands are issued, and this makes the output of trace information more difficult.

Furthermore, it takes at least one trace output clock to output information for the number of execution times, and generally, an operating frequency that is obtained by dividing a CPU clock by ½ or ¼ and that can be transmitted outside a chip is selected as a trace output clock. Therefore, when the ratio of the operating frequency of the CPU and the trace clock is taken into consideration, the rate of output of trace information is lower than the rate of generation of trace information, and trace output will be disabled soon, even when a buffer having an appropriate capacity is prepared. That is, the rate at which output trace information is compressed is low, compared with the actual operation of the CPU.

Further, to trace information other than that concerning a command execution state, like the establishing/non-establishing of a condition for a conditioned execution command, e.g., to trace the operand information, when the operand information is generated, data that have been encoded must be output as trace information. Since trace information includes a packet ID and the effective bit count as overhead information, a problem encountered here is that as the number of times trace information is output is increased, the number of trace information output packets is likewise increased.

### SUMMARY OF THE INVENTION

While taking these problems into account, one objective of the present invention is to provide means for so greatly compressing trace information that the operation of a high-speed CPU incorporated in a processor can be accurately and externally captured. Another objective of the present invention is to provide a development supporting apparatus that employs this processor.

To achieve these objectives, a processor according to a first aspect of the invention comprises a statically scheduled command removal unit which removes a statically scheduled command upon receiving a command issue signal, a command execution condition establishing signal and an execution determination signal consonant with static scheduling an encoding unit which encodes an execution history for commands, except for the static scheduled command, upon receiving the command execution condition establishing signal and the command issue signal which are obtained by the static scheduled command removal unit, and a data packet generator which generates a trace packet upon receiving encoded data obtained by the encoding unit. Incidentally, the static scheduled command is excluded from the command execution condition establishing signal and the command issue signal obtained by the static scheduled command removal unit.

According to this arrangement, for a command for which execution by a compiler is determined in advance, generation of a condition execution flag can be suppressed, so that trace information can be greatly compressed, by employing an execution determination signal in accordance with static scheduling.

A processor according to a second aspect of the invention comprises an encoding unit which encodes an execution history for commands upon receiving a command issue signal, a command execution condition establishing signal, an operand detection signal and operand data, a data packet generator which generates a trace packet upon receiving encoded data obtained by the encoding unit, and a controller which immediately outputs an operand data packet and halting output of an execution flag packet according to the first aspect when the operand detection signal is generated.

According to this arrangement, when the operand detection signal is generated, the output of an execution flag trace packet, as trace data, is not immediately performed, but can be delayed. Therefore, the number of times trace information is output can be reduced, and trace information can be greatly compressed.

A processor according to a third aspect of the invention comprises an encoding unit which encodes an execution history for commands upon receiving a command issue signal, a command execution condition establishing signal, an operand detection signal and operand data, a unit which detects an operand position in a source program, and a data packet generator which receives encoded data obtained by the encoding unit and information concerning the operand position, and generates a trace packet that includes information concerning the operand position.

According to this arrangement, wherein information concerning the operand position is included in a trace packet and is output as trace information, the retrieval of operand data can be collectively processed. Therefore, for the retrieval of execution history using trace information, the processing is simplified, and for the execution history retrieval program, the processing efficiency is improved.

Further, according to the arrangement of the processor of the second aspect, since information concerning the operand position is not included in the trace information, the time where at the operand information is generated may not be specified when only part of the operand information is to be traced. However, with the arrangement of the third aspect, since information concerning the operand position is obtained based on trace information, this problem can be resolved.

A development supporting apparatus according to a fourth aspect of the invention comprises a computer that employs a trace packet generated by a processor according to the first aspect, and that employs a source program, executed by the processor, to execute an execution history retrieval program that retrieves and displays an execution history for the processor, and a unit for unconditionally displaying commands in the source program for which execution is determined by static scheduling, for correlating, with information in the trace packet, commands in the source program for which execution is not determined by static scheduling, for displaying commands when correlated information in the trace packet indicates an execution condition has been established, and for not displaying commands when correlated information in the trace packet indicates an execution condition has not been established.

A development supporting apparatus according to a fifth aspect of the invention comprises a computer that employs a trace packet generated by a processor according to the second or third aspect and a source program, executed by the processor, to execute an execution history retrieval program that retrieves and displays an execution history for the processor.

As described above, according to the invention, since, from among all the conditioned execution commands, the appearance frequency of a conditioned execution command that has not yet been statically scheduled is ⅛ to 1/16, the data compression rate for a branching flag packet can be estimated to be about ⅛ to 1/16. As a result, trace information can be greatly compressed.

Furthermore, according to the invention, when operand information is generated, encoded data are not immediately output as trace information, and the output of the data can be delayed. Thus, the number of times trace information is output can be reduced.

Further, according to the invention, since the information for the operand position is included in a trace packet and is output as trace information, the retrieval of operand data is collectively processed, the processing for the retrieval of execution history is simplified, and the processing efficiency for the execution history retrieval program is improved.

### BRIEF DESCRIPTION OF THE DRAWINGS

FIG. 1 is a block diagram showing the configuration of a processor according to a first embodiment of the present invention;

FIG. 2 is a circuit diagram showing the internal arrangement of a statically scheduled command removal circuit according to the first embodiment of the invention;

FIG. 3 is a block diagram showing the internal arrangement of an encoding circuit according to the first embodiment of the invention;

FIG. 4 is a block diagram showing the internal arrangement of a packet generation circuit according to the first embodiment of the invention;

FIG. 5 is a diagram showing packet IDs stored in a packet ID storage circuit;

FIG. 6 is a diagram showing the format of a trace packet for encoded data;

FIG. 7 is a diagram showing the format of a trace packet for operand data;

FIG. 8 is a block diagram showing the configuration of a development supporting apparatus;

FIG. 9 is a diagram showing example commands for a sample program;

FIG. 10 is a diagram showing a trace packet for sample program execution results;

FIG. 11 is a diagram showing trace information a host computer has obtained from a processor;

FIG. 12 is a flowchart showing execution history retrieval processing performed by the host computer according to the first embodiment of the invention;

FIG. 13 is a diagram showing an execution history retrieved by using trace information;

FIG. 14 is a block diagram showing the configuration of a processor according to a second embodiment of the present invention;

FIG. 15 a block diagram showing the internal arrangement of an encoding circuit according to the second embodiment of the invention;

FIG. 16 is a block diagram showing the internal arrangement of a packet generation circuit according to the second embodiment of the invention;

FIG. 17 is a diagram showing example commands for a sample program;

FIG. 18 is a diagram showing a trace packet for sample program execution results;

FIG. 19 is a diagram showing trace information a host computer has obtained from a processor;

FIG. 20 is a flowchart showing execution history retrieval processing performed by the host computer according to the second embodiment of the invention;

FIG. 21 is a diagram showing an execution history retrieved by using trace information;

FIG. 22 is a block diagram showing the configuration of a processor according to a third embodiment of the present invention;

FIG. 23 is a block diagram showing the internal arrangement of a packet generation circuit according to the third embodiment of the invention;

FIG. 24 is a diagram showing a trace packet for operand data;

FIG. 25 is a diagram showing a trace packet for sample program execution results;

FIG. 26 is a diagram showing trace information a host computer has obtained from a processor;

FIG. 27 is a flowchart showing execution history retrieval processing performed by the host computer according to the third embodiment of the invention;

FIG. 28 is a diagram showing an execution history retrieved by using trace information;

FIG. 29 is a block diagram showing the configuration of a related processor;

FIG. 30 a block diagram showing the internal arrangement of the encoding circuit of the related processor;

FIG. 31 is a block diagram showing the internal arrangement of the packet generation circuit of the related processor;

FIG. 32 is a diagram showing example commands for a sample program;

FIG. 33 is a diagram showing a trace packet for sample program execution results;

FIG. 34 is a diagram showing trace information a host computer has obtained from the processor;

FIG. 35 is a flowchart showing the related execution history retrieval processing performed by a host computer; and

FIG. 36 is a diagram showing an execution history retrieved by using trace information.

### DETAILED DESCRIPTION OF THE PREFERRED EMBODIMENTS

The preferred embodiments of the present invention will now be described while referring to the drawings. The configuration of a development supporting apparatus shown in FIG. 8 is employed in common for all the embodiments, while the arrangement of a processor 1 is described for each of the embodiments.

### First Embodiment

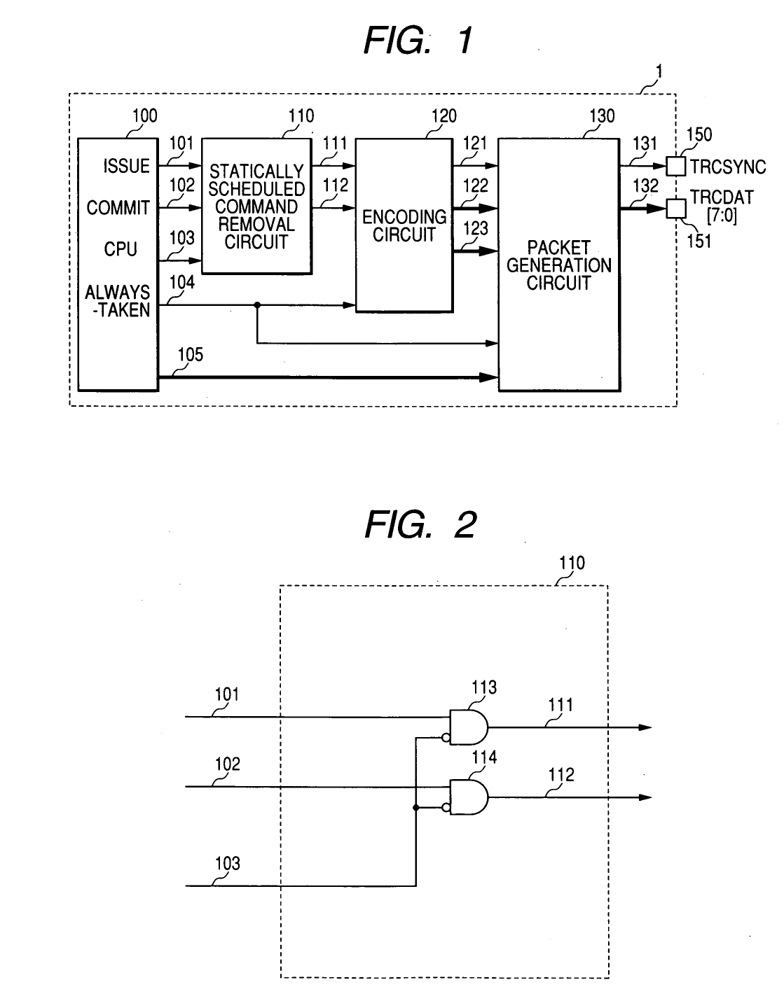

FIG. 1 is a block diagram showing the configuration of a processor according to a first embodiment of the present invention. In FIG. 1, a processor 1 includes: a CPU 100, a statically scheduled command removal circuit 110, an encoding circuit 120, a packet generation circuit 130, a trace state output terminal 150 and a trace data output terminal 151.

The CPU 100 outputs, to the statically scheduled command removal circuit 110, a command issue signal 101, a command execution condition establishing signal 102 and an execution determination signal 103 indicating static scheduling is to be used. The CPU 100 also outputs an operand detection signal 104 to the encoding circuit 120 and the packet generation circuit 130, and outputs operand data 105 to the packet generation circuit 130.

When a command execution condition has been established, the execution issue signal 101 and the command execution establishing signal 102 are set to “1”, but when a command execution condition has not been established, the command issue signal 101 is set to “1” and the command execution condition establishing signal 102 is set to “0”. Further, when a command is to be executed for which execution is determined by static scheduling, an execution determination signal 103 of “1” is output to the statically scheduled command removal circuit 110. And when operand information is generated, the operand detection signal 104 is set to “1”.

The statically scheduled command removal circuit 110 receives the command issue signal 101, the command execution condition establishing signal 102 and the execution determination signal 103, and outputs to the encoding circuit 120, except for a statically scheduled command, a command issue signal 111, and except for a statically scheduled command, a command execution condition establishing signal 112. The details of the statically scheduled command removal circuit 110 will be described later.

The encoding circuit 120 receives the command issue signal 111, except for the statistically scheduled command, the command execution condition establishing signal 112, except for the statically scheduled command, and the operand detection signal 104, and outputs, to the packet generation circuit 130, encoded data output select signal 121, encoded data 122 and a bit count value 123 for the encoded data 122. The details of the encoding circuit 120 will be described later.

The packet generation circuit 130 receives the encoded data output select signal 121, the encoded data 122, the encoded data count value 123, the operand detection signal 104 and operand data 105, and outputs a trace packet output state signal 131 to the trace state output terminal 150, while outputting a trace packet 132 to the trace data output terminal 151. The details of the packet generation circuit 130will be described later.

FIG. 2 is a circuit diagram showing the internal arrangement of the statically scheduled command removal circuit 110. In FIG. 2, the statically scheduled command removal circuit 220 includes mask circuits 113 and 114.

The mask circuit 113 calculates the logical product of the command issue signal 101 and the inverted signal of the execution determination signal 103, and based on the logical product, generates the command issue signal 111, excluding a statically scheduled command. The mask circuit 114 calculates the logical product of the command execution condition establishing signal 102 and the inverted signal of the execution determination signal 103, and based on the logical sum, generates the command execution condition establishing signal 112, excluding a statically scheduled command.

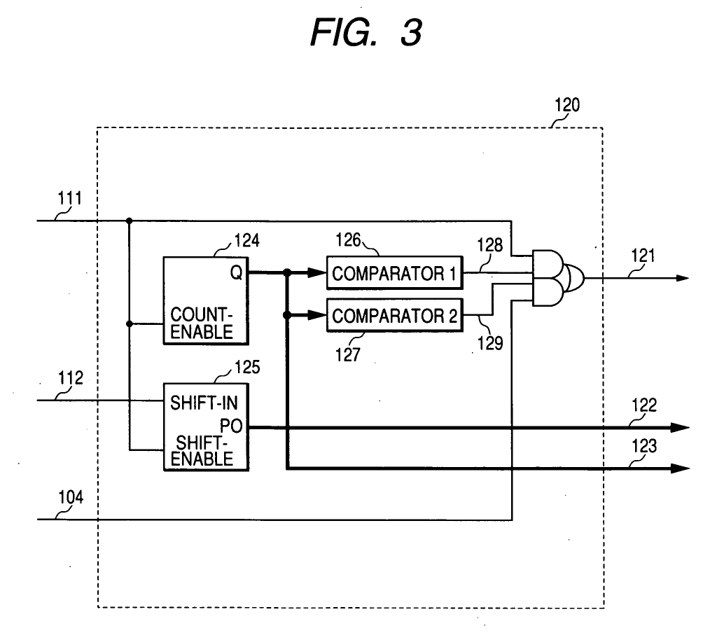

FIG. 3 is a block diagram showing the internal arrangement of the encoding circuit 120. In FIG. 3, the encoding circuit 120 includes a counter 124, a shift register 125 and comparators 126 and 127.

The shift register 125 regards as a shift enable signal the command issue signal 111, except for the statically scheduled command shifts in the command execution condition establishing signal 112, except for the statically scheduled command, and generates the encoded data 122, including the meaning of a flag string that indicates the execution state of a command, except for the statically scheduled command. The counter 124 regards as a count enable signal the command issue signal 111, except for the statically scheduled command, and generates the bit count value 123 for the encoded data 122.

The comparator 126 compares the bit count value 123 with a value set in the comparator 126, and when the values match, sets a count match signal 128 to “1”. The comparator 127 compares the count value 123 with “0”, and when the bit count value 123 is not “0”, sets a count match signal 129 to “1”. The encoded data output select signal 121 is generated based on the logical sum of the logical product of the count match signal 128 and the command issue signal 111, except for the statically scheduled command, and the logical product of the count match signal 129 and the operand detection signal 104.

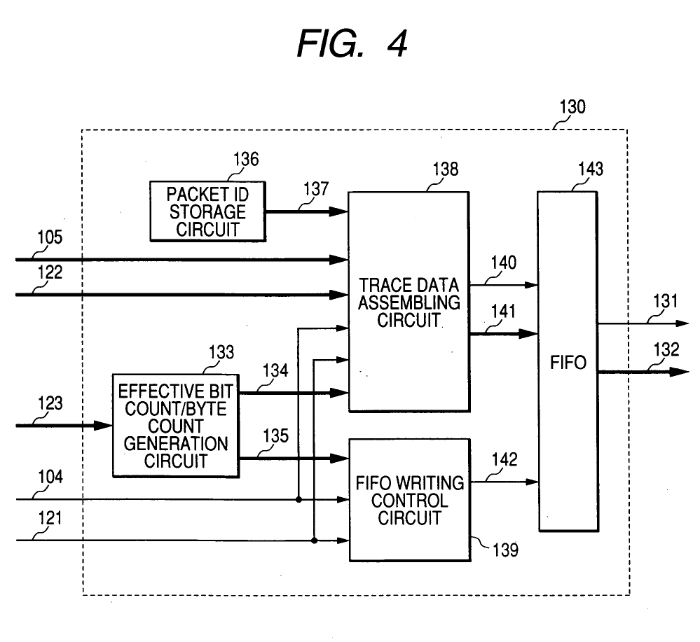

FIG. 4 is a block diagram showing the internal arrangement of the packet generation circuit 130. In FIG. 4, the packet generation circuit 130 includes: an effective bit count/byte count generation circuit 133, a packet ID storage circuit 136, a trace data assembling circuit 138, an FIFO writing control circuit 139 and an FIFO queue 143.

The effective bit count/byte count generation circuit 133 generates an effective bit count 134 in accordance with the least significant three bits of the bit count value 123, and generates an effective byte count 135 in accordance with a value equal to or greater than the least significant fourth bit of the bit count value 123. The packet ID storage circuit 136 stores a packet ID 137, which is a constant.

The trace data assembling circuit 138 receives the packet ID 137, the encoded data 122, the effective bit count 134, the encoded data output select signal 121, the operand detection signal 104 and the operand data 105. Further, when the encoded data output select signal 121 indicates “1”, the trace data assembling circuit 138 generates a data string consisting of the packet ID 137, the effective bit count 134 and the encoded data 122, divides this data string into bytes, and outputs the data byte by byte as trace data 141.

Further, when the operand detection signal 104 indicates “1”, the trace data assembling circuit 138 generates a data string consisting of the packet ID 137 and the operand data 105, divides this data string into bytes, and outputs the data byte by byte as trace data 141.

In addition, when outputting the first effective data of those output as the trace data 141, the trace data assembling circuit 138 also outputs a trace data output state signal 140 of “1”. Then, when the second and following trace data 141 are output, the trace data output state signal 140 is set to “0”.

The FIFO writing control circuit 139 receives the effective byte count 135, the encoded data output select signal 121 and the operand detection signal 104, and generates a write enable signal 142 to be transmitted to the FIFO queue 143 that handles the trace data output state signal 140 and the trace data 141.

The FIFO queue 143 receives the trace data output state signal 140, the trace data 141 and the write enable signal 142, shifts the data received in synchronization with a reference clock for trace output, and outputs a trace packet output state signal 131 and a trace packet 132 in the order in which they were input.

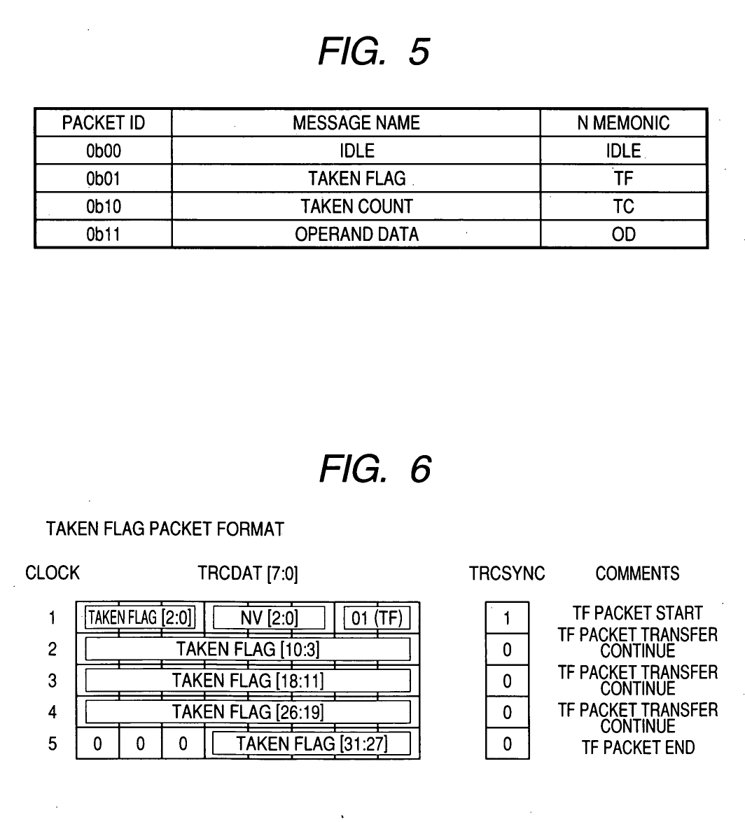

The packet IDs stored in the packet ID storage circuit 136 are shown in FIG. 5, and the contents of the packet IDs are the same as those described for the related example.

“Taken Flag” and “Taken Count” in entry “Message Name” in this embodiment will now be described. “Taken Flag” is a flag string (a bit string indicating “1” when, at the time a command other than a statically scheduled command is issued, a condition for the execution of the command is established, or a bit string indicating “0” when the command execution condition is not established) that indicates a command execution state, and is output as encoded data upon receiving the command issue signal 111, for which a statically scheduled command is excluded, and the command execution condition establishing signal 112, for which a statically scheduled command is excluded.

“Taken Count” is encoded data, indicating the number of times the command execution condition was established (the number of times the command execution condition establishing signal 112=“1” was repeated when commands other than statically scheduled commands were issued), that were output upon the reception of the command issue signal 111, for which statically scheduled commands are excluded, and upon the reception of the command execution condition establishing signal 112, for which statically scheduled commands are excluded.

An explanation will now be given for an example encoding of “Taken Flag”. When the encoded data 122 are to be output as trace data, a format in FIG. 6 is employed for a trace packet output by the FIFO queue 143, the contents of which were previously described in the related example.

Specifically, “clock” denotes a reference clock for trace output. TRCDAT[7:0] denotes the format of the trace packet 132, output to the trace data output terminal 151, and includes: Taken Flag[31:0], indicating the value of the encoded data 122; NV[2:0], indicating the value of the effective bit count 134 of the encoded data 122; and TF, indicating the value of the packet ID. TRCSYNC denotes the value of the trace packet output state signal 131 output to the trace state output terminal 150. And “comments” denotes a packet transfer state.

As described above, in synchronization with “clock”, TF, NV[2:0] and Taken Flag[31:0] are sequentially output byte by byte as trace data.

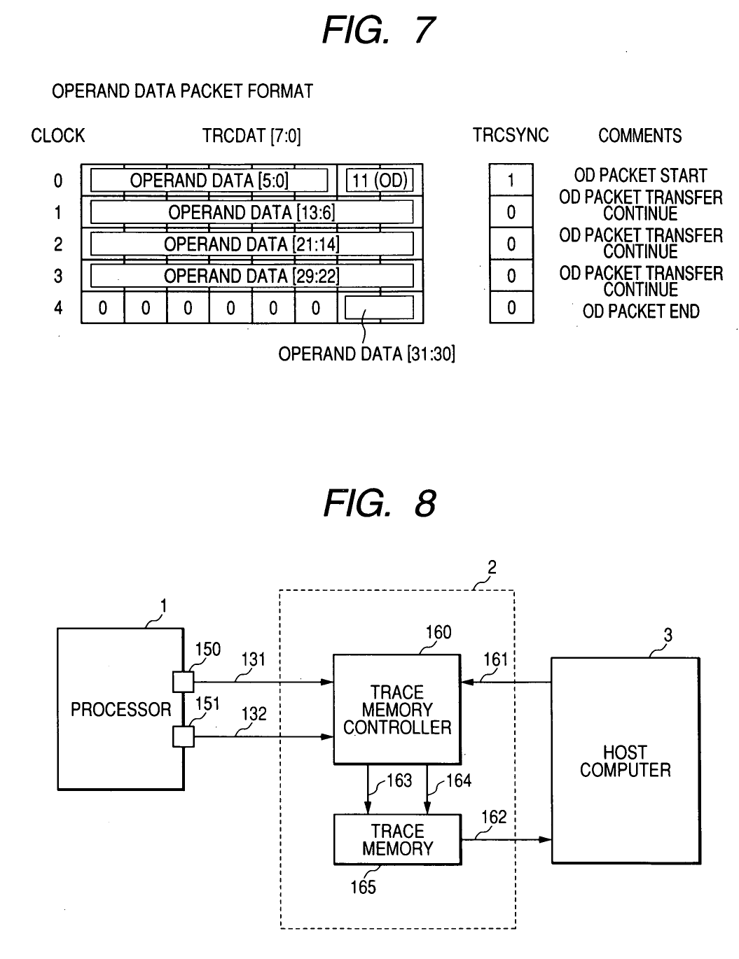

In order to output the operand data 105 as trace data, the format in FIG. 7 is employed for a trace packet output by the FIFO queue 143. The contents employed for the format were previously described in the related example.

Specifically, “clock” denotes a reference clock for trace output and TRCDAT[7:0] denotes the format of the trace packet 132, output to the trace data output terminal 151, and includes: Operand Data[31:0], used to indicate the value of operand data; and OD, used to indicate the value of the packet ID.

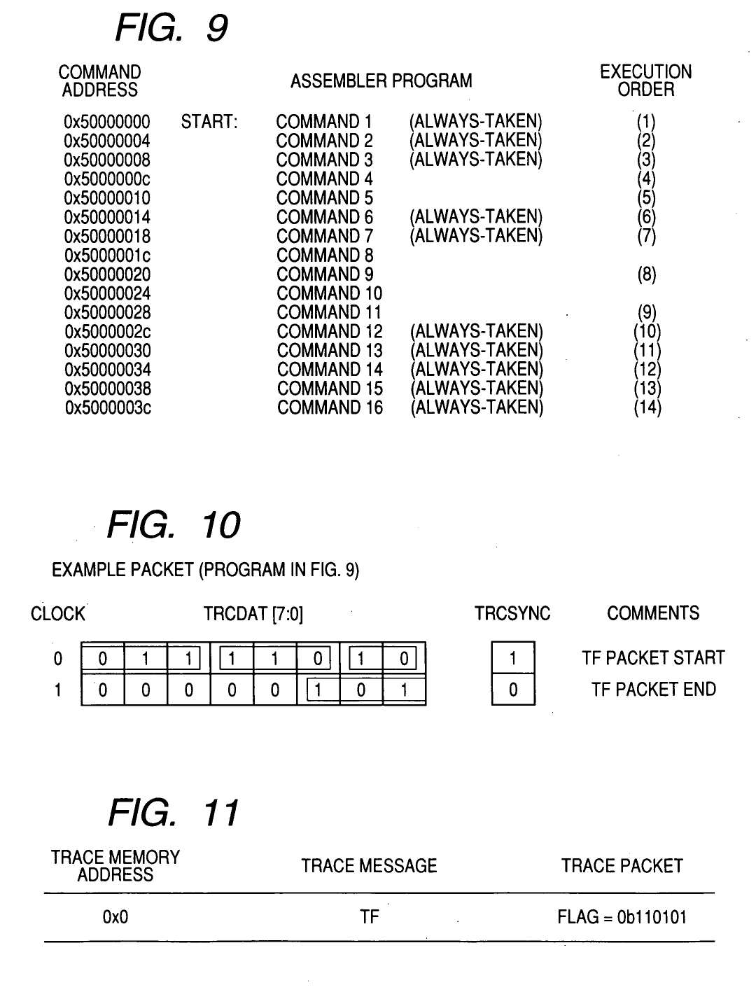

While referring to FIGS. 9 to 13, an explanation will now be given for the state wherein the host computer 3 employs this arrangement to obtain trace data from the processor 1, and retrieves data for an execution history. In this embodiment, assume that the comparison value employed by the comparator 126 in FIG. 3 is “6”.

FIG. 9 is a diagram for a sample program that shows example commands, including “command addresses”, an “assembler program” and an “execution order”. For the program, commands from “command 1”, in the “execution order” (1), to “command 16”, in the “execution order” (14), are sequentially executed.

Commands labeled “(ALWAYS-TAKEN)” are commands the CPU always executes, and commands not labeled “(ALWAYS-TAKEN)” are commands for which “Taken” or “Not Taken” cannot be determined if the CPU does not execute these commands.

In this example, assume that “command 8” and “command 10” are commands that were not executed, and that, of the commands that were executed, “command 1 to command 3”, “command 6 and command 7” and command 12 to command 16” are commands that the CPU always executes.

In FIG. 9, when commands are executed in order, beginning at address 0×50000000, the command issue signal 101 is changed sequentially to “111111111111111”, in synchronization with the operating frequency of the CPU, while at the same time, the command execution condition establishing signal 102 is changed to “1111111010111111”, and the execution determination signal 103 is changed to “1110011000011111”.

In response to these changes, the command issue signal 111, which excludes statically scheduled commands, is output by the statically scheduled command removal circuit 110 and is changed to “0001100111100000”, and the command execution condition establishing signal 112, which excludes statically scheduled commands, is changed to “0001100010100000”.

In accordance with these changes, the encoded data 122, which is output by the shift register 125 of the encoding circuit 120, is changed to “110101”. Further, bit count value 123 for the counter 124 is incremented to “0×6”, while the value of the command issue signal 111, which excludes statically scheduled commands, is regarded as a count enable signal. When the bit count value 123 reaches “0×6”, the count match signal 128 becomes “1”, as does the encoded data output select signal 121.

The effective bit count/byte count generation circuit 133 of the packet generation circuit 130 outputs an effective bit count 134 of “0b011”, in accordance with the three least significant bits of (bit count value “0×6”+bit count value “0×3” for NV+bit count “0×2” for the packet ID), and outputs an effective byte count 135 of “0b1”, in accordance with a value that is equal to or greater than the fourth least significant bit.

Upon receiving the effective bit count 134, the trace data assembling circuit 138 of the packet generation circuit 130 arranges, beginning with the least significant bit, the packet ID=value “0b01” for TF, NV=value “0b011” for the effective bit count 134 and Taken Flag=“0b110101”.

When the value of the encoded data output select signal 121 becomes “1”, in synchronization with the reference clock for trace output, the FIFO writing control circuit 139 sets the write enable signal 142, which is to be transmitted to the FIFO queue 143, to “1” two times (=the effective byte count 135+1).

In accordance with the write enable signal 142, data generated by the trace data assembling circuit 138 are output byte by byte twice to the FIFO queue 143. Furthermore, when data for the first byte is output, a trace data output state signal 140 of “1” is also output.

The FIFO queue 143 receives the data and the trace data output state signal 140, and transmits the trace packet 132 and the trace packet output state signal 131. FIG. 10 is a diagram showing a trace packet when the sample program in FIG. 9 is executed.

The host computer 3 receives a packet shown in FIG. 10, and extracts the packet ID=TF from TRCDAT[1:0] and NV=3 from TRCDAT[4:2]. Since NV=3, information is obtained indicating the encoded data FLAG=0b110101.

FIG. 11 is a diagram showing trace information that the host computer 3 has obtained from the processor 1 in this manner.

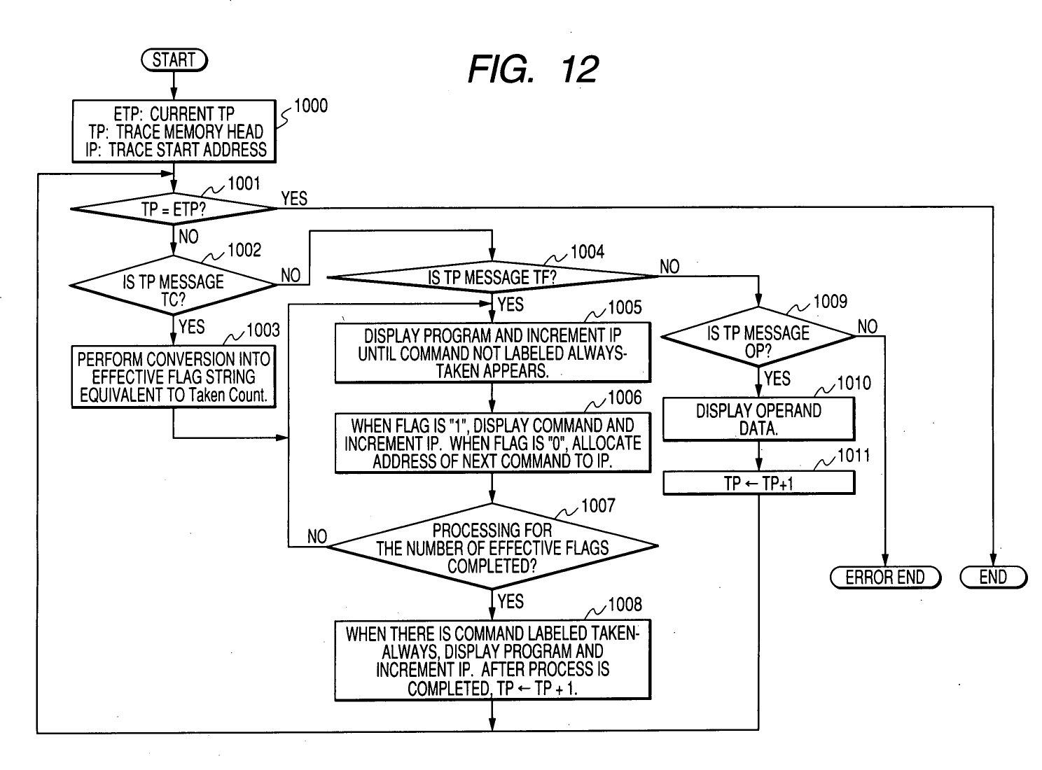

An explanation will now be given for the processing wherein the host computer 3 retrieves an execution history by employing the sample program in FIG. 9 and the trace information in FIG. 11. FIG. 12 is a flowchart showing the algorithm for the execution history retrieval processing performed by the host computer 3.

In FIG. 12, at step 1000, IP is assigned as address 0×5000000, TP is assigned as address 0×0, and ETP is assigned as address 0×1. Since TP ETP, program control skips step 1001 and advances to step 1002. Then, since the trace message is TF, program control advances to steps 1004 and 1005.

Until a command not indicated by ALWAYS-TAKEN appears, command 1 at address 0×50000000, command 2 at address 0×50000004 and command 3 at address 0×50000008 are displayed. When command 4, which is not labeled ALWAYS-TAKEN, appears, program control moves to step 1006. Since a flag has the value “1”, command 4 is displayed and IP is incremented to address 0×50000010.

Since effective flags remain, program control is returns to step 1005, and since command 5, which is not labeled ALWAYS-TAKEN, appears, program control advances to step 1006. Then since the flag has a value of “1”, command 5 is displayed and IP is incremented to address 0×50000014.

Since effective flags still remain, program control is again returned to step 1005, command 6 at address 0×50000014 and command 7 at address 0×50000018 are displayed, and since command 8, which is not labeled ALWAYS-TAKEN, appears, program control advances to step 1006. Then, since the flag has a value of “0”, address 0×50000020, for the next command 9, is allocated to IP.

Since effective flags still remain, program control returns to step 1005, and since command 9, which is not labeled ALWAYS-TAKEN, appears, program control advances to step 1006. Then, since the flag has a value of “1”, command 9 is displayed at address 0×50000020 and IP is incremented to address 0×50000024.

Since there are still effective flags, program control returns to step 1005, and since command 10, which is not labeled ALWAYS-TAKEN, appears, program control advances to step 1006. Then, since the flag has a value of “0”, address 0×50000028 for the next command 11 is allocated to IP.

Since there is still an effective flag, program control returns to step 1005, and since command 11, which is not labeled ALWAYS-TAKEN, appears, program control advances step 1006. Then, since the flag has a value of “1”, command 11 is displayed at address 0×50000028.

Since there are no more effective flags, command 12 at address 0×5000002c, command 13 at address 0×50000030, command 14 at address 0×50000034, command 15 at address 0×50000038 and command 16 at address 0×5000003c are displayed, and TP is assigned to address 0×1. Program control is thereafter returned to step 1001. Then, since TP=ETP is determined, the execution history retrieval processing is terminated.

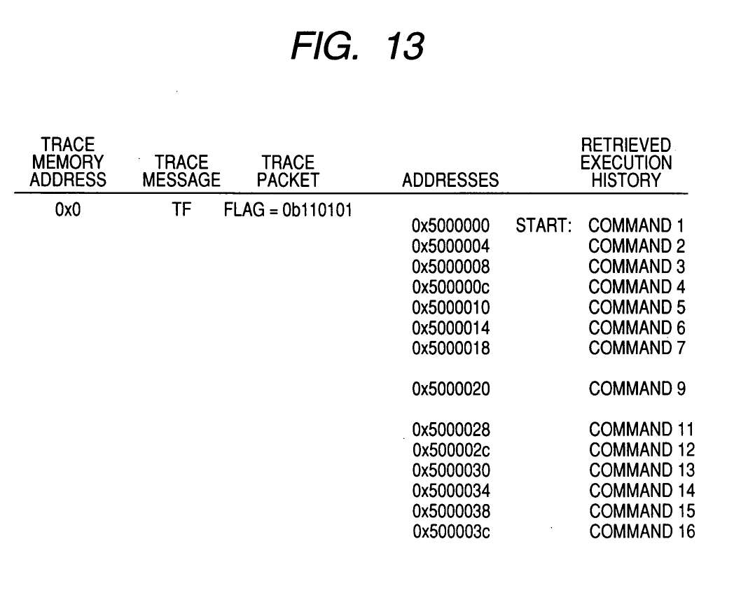

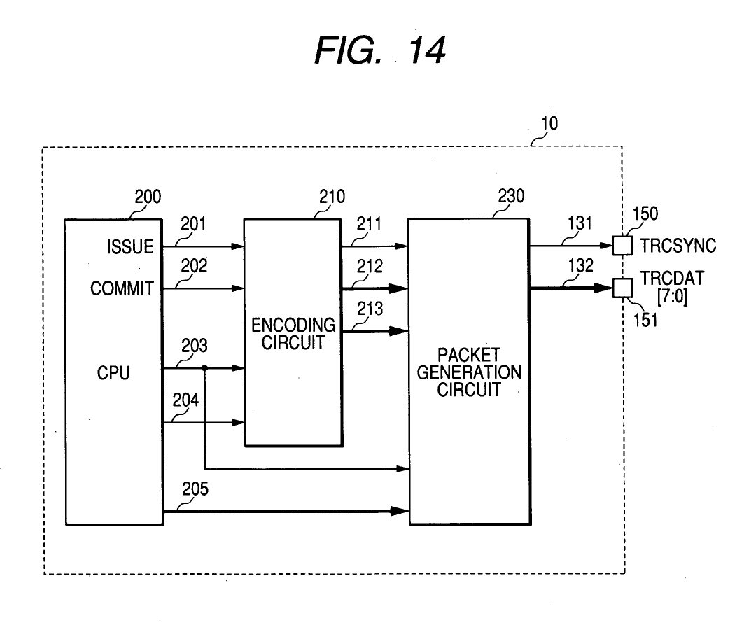

FIG. 13 is a diagram showing an execution history obtained through this processing. In FIG. 13, a “trace memory address”, a “trace message”, a “trace packet”, “addresses” and a “retrieval execution history” are shown, and it is confirmed that the sample program shown in FIG. 9 can be retrieved.

Conventionally, Taken Flags, including commands labeled ALWAYS-TAKEN, are output as trace packets. However, in this embodiment, since only commands not labeled ALWAYS-TAKEN are encoded, Taken Flag bits of trace data can be compressed in a number equivalent to the number of commands labeled ALWAYS-TAKEN.

### Second Embodiment

FIG. 14 is a block diagram showing the configuration of a processor according to a second embodiment of the present invention. In FIG. 14, a processor 1 includes: a CPU 200, an encoding circuit 210, a packet generation circuit 230, a trace state output terminal 150 and a trace data output terminal 151.

The CPU 200 outputs to the encoding circuit 210 a command issue signal 201, a command execution condition establishing signal 202, an operand detection signal 203 and an encoded data output mode signal 204. The CPU 200 also outputs operand data 205 to the packet generation circuit 230.

When a command execution condition is established, the command issue signal 201 and the command execution condition establishing signal 202 become “1”, and when the command execution condition is not established, the command issue signal 201 becomes “1” and the command execution condition establishing signal 202 becomes “0”. When operand information is generated, the operand detection signal 203 becomes “1”.

The encoded data output mode signal 204 is a mode signal used to designate whether the operand detection signal 203 should be included in a condition for generating an encoded data output select signal 211. When the encoded data output mode signal 204 indicates “1”, the operand detection signal 203 should not be included in the condition for generating the encoded data output select signal 211.

The encoding circuit 210 receives the command issue signal 201, the command execution condition establishing signal 202, the operand detection signal 203 and the encoded data output mode signal 204, and outputs to the packet generation circuit 230 the encoded data output select signal 211, the encoded data 212 and a bit count value 213 for the encoded data 212. The details of the encoding circuit 210 will be described later.

The packet generation circuit 230 receives the encoded data output select signal 211, the encoded data 212, the bit count value 213 for the encoded data 212, the operand detection signal 203 and operand data 205, and outputs a trace packet output state signal 131 to the trace state output terminal 150, while outputting a trace packet 132 to the trace data output terminal 151. The details of the packet generation circuit 230 will be described later.

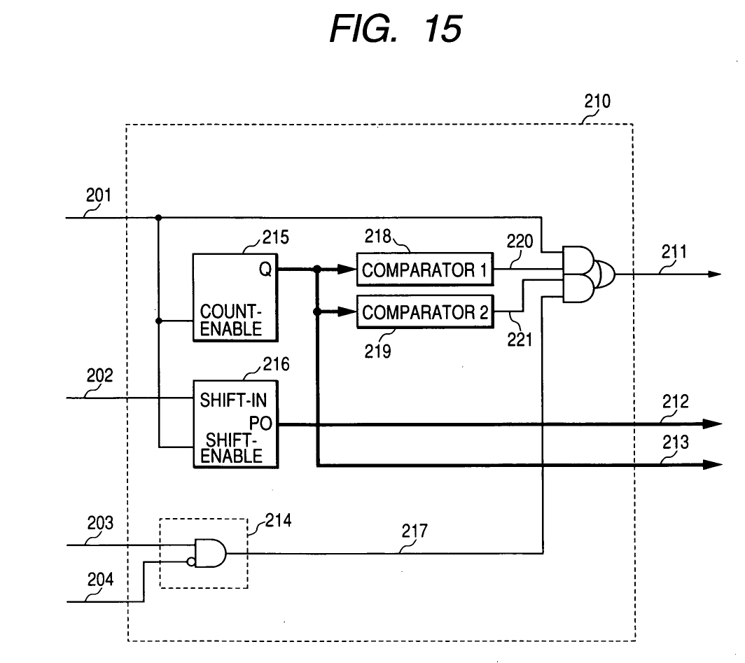

FIG. 15 is a block diagram showing the internal arrangement of the encoding circuit 210. In FIG. 15, the encoding circuit 210 includes a mask circuit 214, a counter 215, a shift register 216 and comparators 218 and 219.

The mask circuit 214 employs the logical product of the operand detection signal 203 and the inverted signal of the encoded data output mode signal 204 to generate an encoded data output select signal 217 consonant with operand detection.

The shift register 216 regards the command issue signal 201 as a shift enable signal, shifts in the command execution condition establishing signal 202, and generates the encoded data 212, including the meaning of a flag string that indicates the execution state of a command. The counter 215 regards the command issue signal 201 as a count enable signal, and generates the bit count value 213 of the encoded data 212.

The comparator 218 compares the bit count value 213 with a value set in the comparator 218, and when the values match, sets acount match signal 220 to “1”. The comparator 219 compares the bit count value 213 with “0”, and when the bit count value 213 is not “0” sets a count match signal 221 to “1”. The encoded data output select signal 211 is generated based on the logical sum of the logical product of the count match signal 220 and the command issue signal 201, and the logical product of the count match signal 221 and the encoded data output select signal 217 consonant with operand detection.

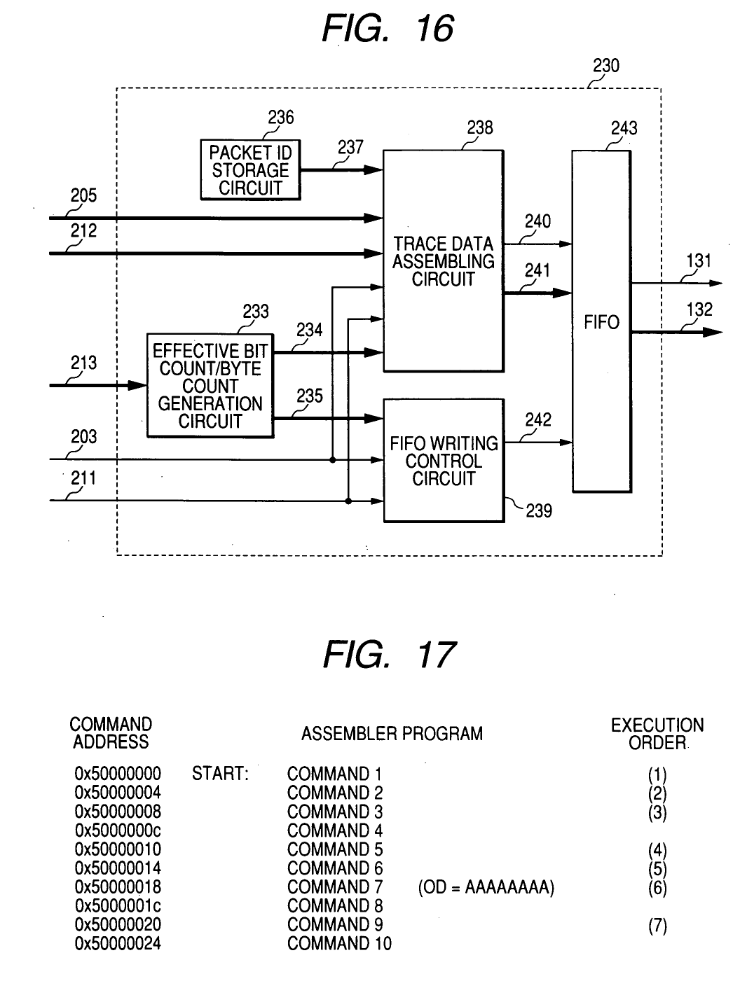

FIG. 16 is a block diagram showing the internal arrangement of the packet generation circuit 230. In FIG. 16, the packet generation circuit 230 includes: an effective bit count/byte count generation circuit 233, a packet ID storage circuit 236, a trace data assembling circuit 238, an FIFO writing control circuit 239 and an FIFO queue 243.

The effective bit count/byte count generation circuit 233 generates an effective bit count 234 in accordance with the three least significant bits of the bit count value 213, and generates an effective byte count 235 in accordance with a value equal to or greater than the fourth least significant bit of the bit count value 213. The packet ID storage circuit 236 stores a packet ID 237, which is a constant.

The trace data assembling circuit 238 receives the packet ID 237, the operand data 205, the encoded data 212, the effective bit count 234, the operand detection signal 203 and the encoded data output select signal 211. When the encoded data output select signal 211 indicates “1”, the trace data assembling circuit 238 generates a data string consisting of the packet ID 237, the effective bit count 234 and the encoded data 212, divides this data string into bytes, and outputs the data byte by byte as trace data 241.

Further, when the operand detection signal 203 indicates “1”, the trace data assembling circuit 238 generates a data string consisting of the packet ID 237 and the operand data 205, divides this data string into bytes, and outputs the data byte by byte as the trace data 241.

In addition, when outputting the first effective data of those output as the trace data 241, the trace data assembling circuit 238 also outputs a trace data output state signal 240 of 1”. When the second and following trace data 241 are output, the trace data output state signal 240 is set to “0”.

The FIFO writing control circuit 239 receives the effective byte count 235, the encoded data output select signal 211 and the operand detection signal 203, and generates a write enable signal 242 to be transmitted to the FIFO queue 243 that handles the trace data output state signal 240 and the trace data 241.

The FIFO queue 243 receives the trace data output state signal 240, the trace data 241 and the write enable signal 242, shifts data received in synchronization with a reference clock for trace output, and outputs a trace packet output state signal 231 and a trace packet 232 in the order in which they were input.

The packet IDs stored in the packet ID storage circuit 236 are shown in FIG. 5; when the encoded data 212 are output as trace data, the format used for trace packets output by the FIFO queue 243 is shown in FIG. 6; and when the operand data 205 are output as trace data, the format used for trace packets output by the FIFO queue 243 is shown in FIG. 7. The contents of the packet ID and the formats were previously explained in the related example and in the first embodiment.

Specifically, in FIG. 7, “clock” denotes a reference clock for trace output and TRCDAT[7:0] denotes the format of the trace packet 232, output to the trace data output terminal 151, and includes: Operand Data[31:0], indicating the value of the operand data 205; and OD, indicating the value of the packet ID.

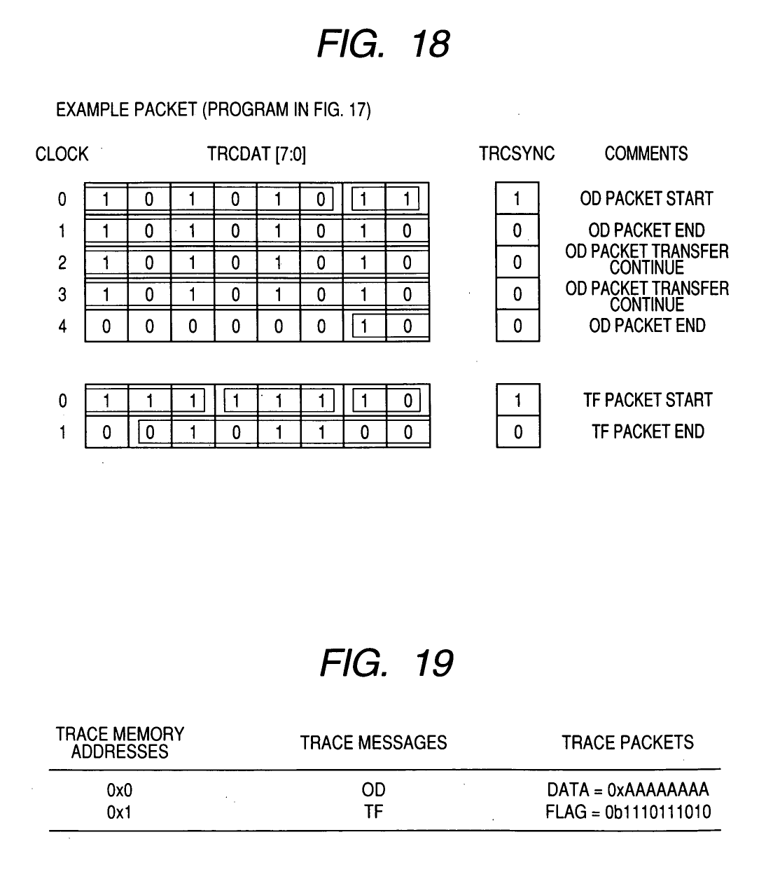

While referring to FIGS. 17 to 21, an explanation will now be given for the state wherein the host computer 3 obtains trace data from the processor 1 with this arrangement, and retrieves an execution history. In this embodiment, assume that the comparison value employed by the comparator 218 in FIG. 15 is “10”.

FIG. 17 is a diagram showing example commands of a sample program, and “command addresses”, an “assembler program” and an “execution order” are shown. To perform a program, commands from “command 1” in “execution order” of (1) to “command 9” in “execution order” of (7) are sequentially executed.

In this example, assume that “command 4”, “command 8” and “command 10” were commands that are not executed, and that “command 7” is a command to generate operand data OD=0×AAAAAAAA.

In FIG. 17, when commands are executed beginning at address 0×50000000, the command issue signal 201 is sequentially changed to “1111111111” in synchronization with the operating frequency of the CPU 200, and at the same time, the command execution condition establishing signal 202 is changed to “1110111010”.

Further, when command 7 at address 0×50000018 is executed, the operand detection signal 203 is changed to “1”, and “0×AAAAAAAA” is output as the operand data 205. In this case, assume that the setup value of the encoded data output mode signal 204 is “1”.

Upon receiving the command issue signal 201 and the command execution condition establishing signal 202, the encoded data 212 output from the shift register 216 of the encoding circuit 210 is changed to “1110111010”. The bit count value 213 of the counter 215 is incremented to “0×a” while the value of the command issue signal 201 is regarded as a count enable signal. When the bit count value 213 reaches “0×7”, command 7 is executed and the operand detection signal 203 is changed to “1”.

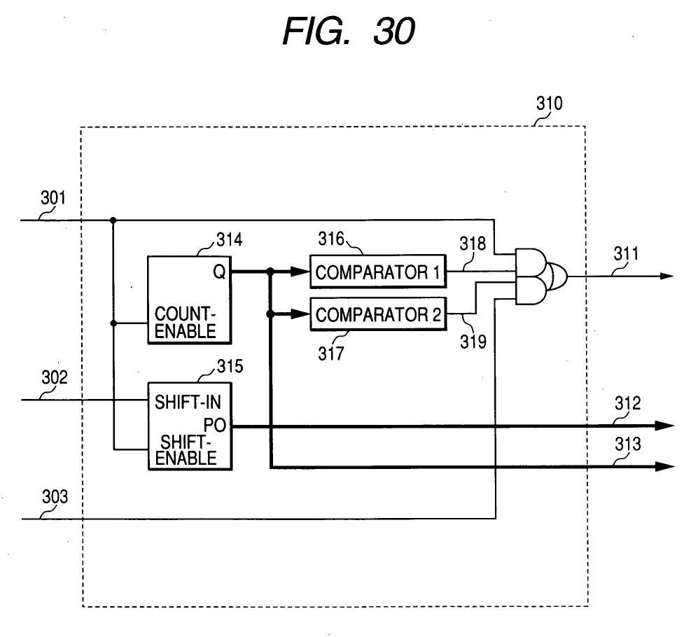

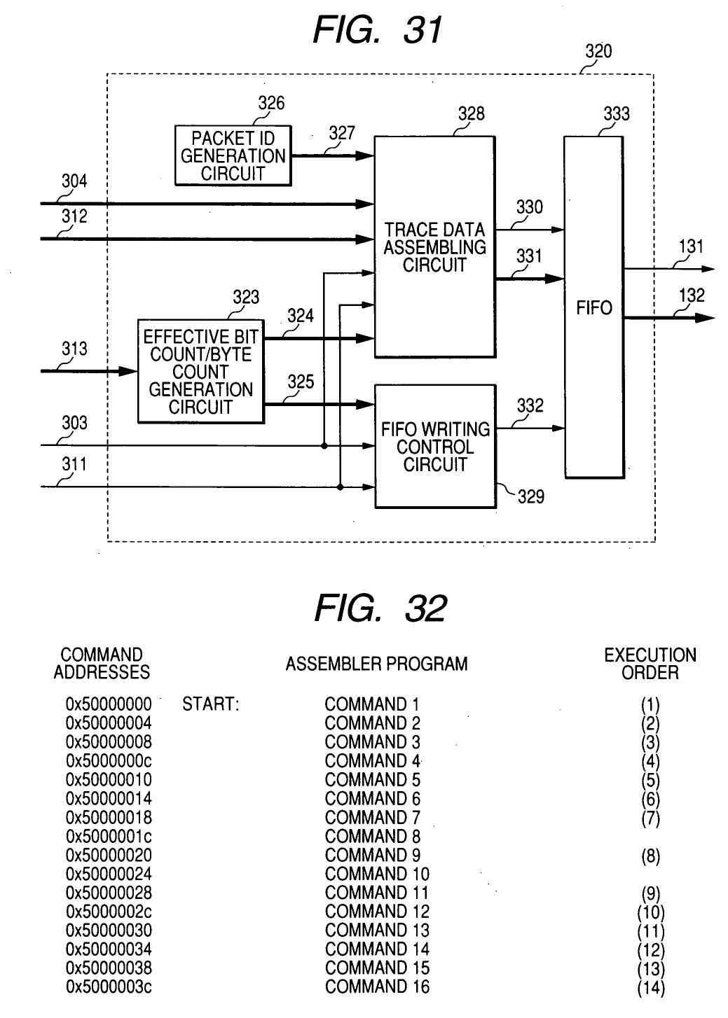

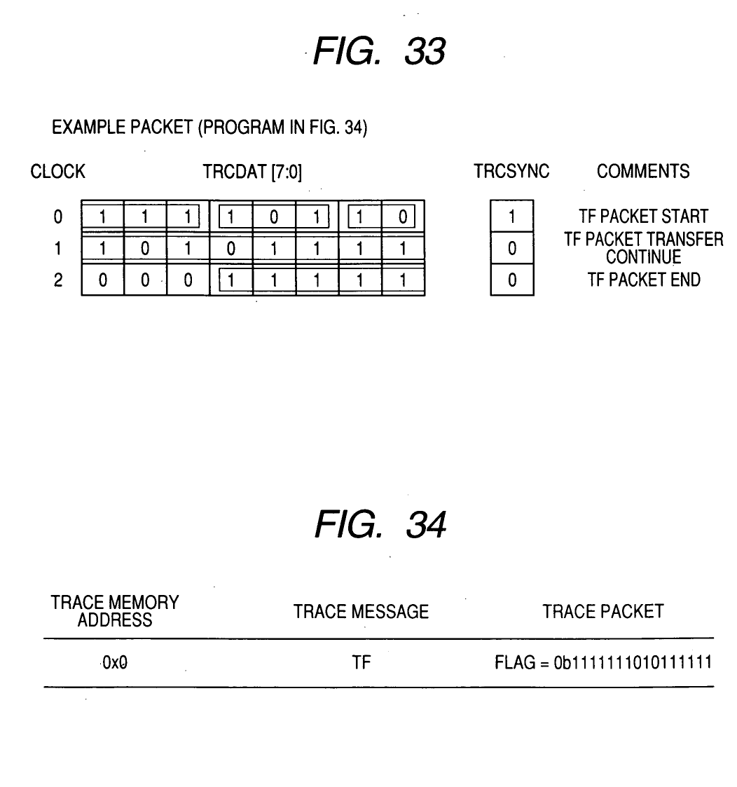

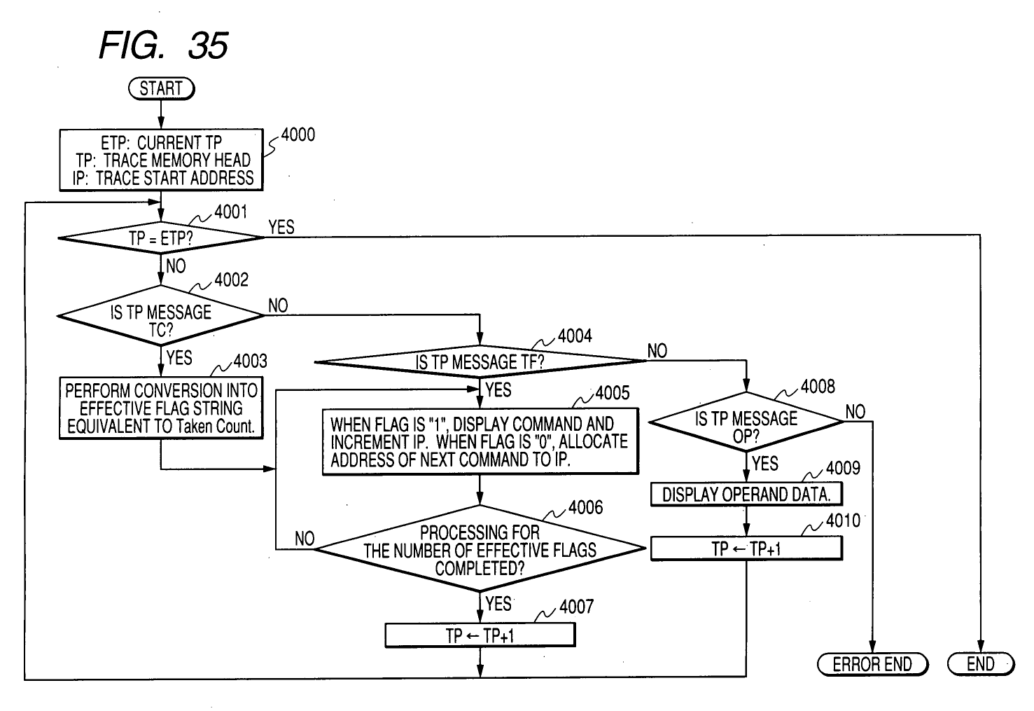

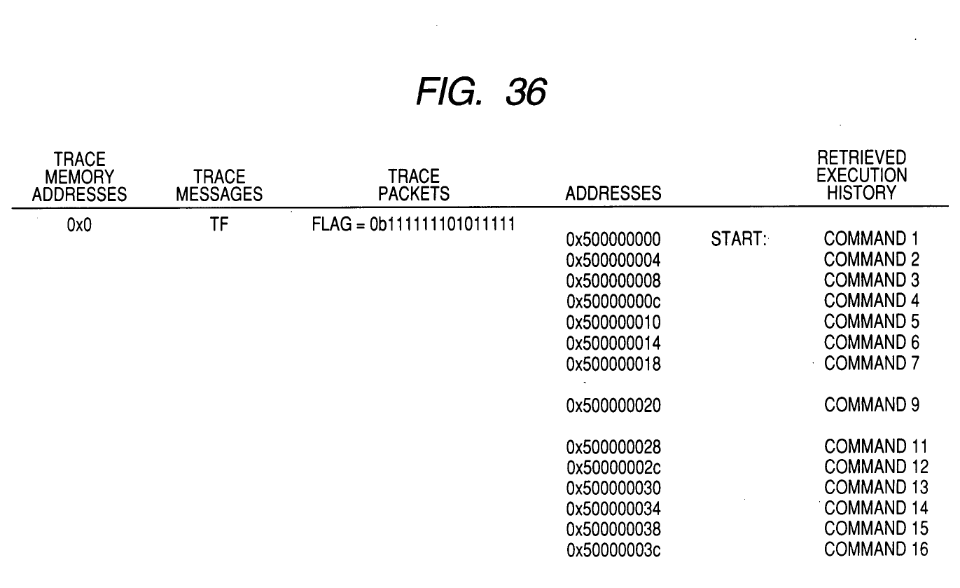

At this time, if the encoding circuit 210, like the encoding circuit 310 in FIG. 30 in the related case, does not include the mask circuit 214, the encoded data output select signal 211 is changed to “1”, and at this time, the encoded data 212 are output as trace data.

However, in this embodiment, the operand detection signal 203=“1” is masked by the inverted signal (=“0”) of the encoded data output mode signal 204, and the encoded data output select signal 217 consonant with operand detection is changed to “0”. Therefore, at this time, the encoded data output select signal 211 indicates “0”. Thereafter, when the bit count value 213 of the counter 215 is incremented to “0×a”, the count match signal 220 becomes “1”, and the encoded data output select signal 211 is set to “1”.

When the operand detection signal 203 becomes “1”, the effective byte count 235 of “0b100” is output in accordance with the value equal to or greater than the least fourth significant bit of (bit count “0×20” of operand data+bit count “0×2” of the packet ID).

Upon receiving this byte count 235, the trace data assembling circuit 238 of the packet generation circuit 230 arranges, beginning at the least significant bit, the packet ID=OD value “0b11” and Operand Data=“0×AAAAAAAA”.

When the value of the operand detection signal 203 is changed to “1”, in synchronization with the reference clock for trace output, the FIFO writing control circuit 239 sets, to “1” five times (=the effective byte count 235+1), the write enable signal 242 to be transmitted to the FIFO queue 243.

In accordance with the write enable signal 242, data generated by the trace data assembling circuit 238 are output byte by byte to the FIFO queue 243 five times. Furthermore, when the first byte of the data is output, the trace data output state signal 240 of “1” is output.

Next, when the encoded data output select signal 211 is changed to “1”, the effective bit count 234 of “0b111” is output in accordance with the least three significant bits of (count value “0×a”+bit count “0×3” of NV+bit count “0×2” of the packet ID), and the effective byte count 235 of “0b1” is output in accordance with the value equal to or greater than the least fourth significant bit.

Upon receiving the effective bit count 234, the trace data assembling circuit 238 of the packet generation circuit 230 arranges, beginning with the least significant bit, the packet ID=value “0b01” of TF, NV=value “0b111” of the effective bit count 234 and Taken Flag=“0b1110111010”.

After the value of the encoded data output select signal 211 is changed to “1”, in synchronization with the reference clock for trace output, the FIFO writing control circuit 239 sets, to “1” two times (=the effective byte count 235+1), the write enable signal 242 to be transmitted to the FIFO queue 243.

In accordance with the write enable signal 242, data generated by the trace data assembling circuit 238 are output byte by byte to the FIFO queue 243 two times. When the first byte of the data is output, the trace data output state signal 240 of “1” is output.

The FIFO 243 receives the data and the trace data output state signal 240, and outputs the trace packet 132 and the trace packet output state signal 131. FIG. 18 is a diagram showing a trace packet when the sample program in FIG. 17 is executed.

The host computer 3 receives a packet shown in FIG. 18, and first, obtains packet ID=OD from TRCDAT[1:0], and then obtains operand data DATA 0×AAAAAAAA.

Then, the host computer 3 obtains packet ID=TF from TRCDAT[1:0], and NV=7 from TRCDAT[4:2]. Since NV=7, encoded data FLAG=0b1110111010 is obtained. FIG. 19 is a diagram showing trace information that the host computer 3 has obtained form the processor 1 in this manner.

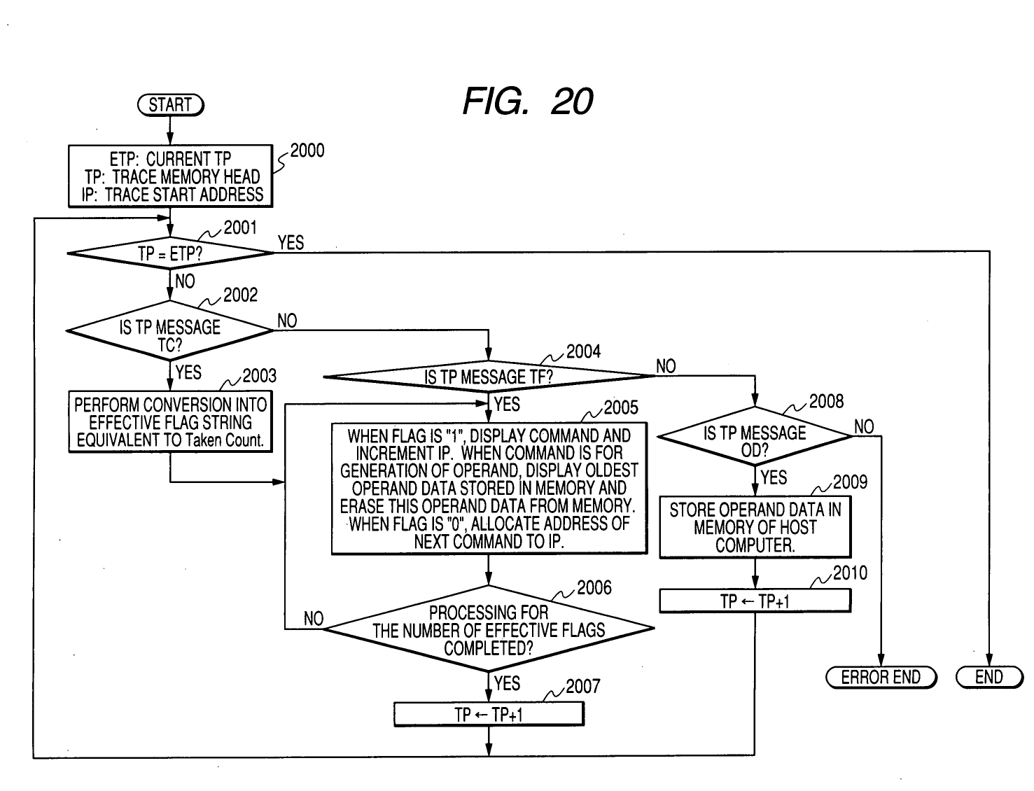

An explanation will now be given for the processing wherein the host computer 3 retrieves an execution history by employing the sample program in FIG. 17 and the trace information in FIG. 19. FIG. 20 is a flowchart showing the algorithm for the execution history retrieval processing performed by the host computer 3.

In FIG. 20, at step 2000, IP is assigned to address 0×50000000, TP is assigned to address 0×0, and ETP is assigned to address 0×2. Since TP#ETP, program control skips step 2001 and advances to step 2002, and since a trace message is OD, advances to steps 2008 and 2009. Then, information that OD=0×AAAAAAAA is stored in the memory of the host computer 3, and TP is assigned to address 0×1. Program control is thereafter returned to step 2001.

Since TP≠ETP, program advances to step 2002, and since a trace message is TF, advances to steps 2004 and 2005. Since the value of a flag is “1”, command 1 is displayed at address 0×50000000, and IP is incremented to address 0×50000004.

Since effective flags still remain and the value of the next flag is “1”, command 2 is displayed at address 0×50000004, and IP is incremented to address 0×50000008. Similarly, command 3 is displayed at address 0×50000008, and since effective flags still remain and the value of the next flag is “0”, address 0×50000010 of the next command 5 is allocated to IP.

Since effective flags still remain and the value of the next flag is “1”, command 5 is displayed at address 0×50000010, and IP is incremented to address 0×50000014. Likewise, command 6 and command 7 are displayed respectively at address 0×50000014 and address 0×50000018.

At this time, since command 7 is a command to generate operand data, the oldest operand data OD=0×AAAAAAAA that is stored in the memory of the host computer 3 is displayed, and this operand data is erased from the memory.

Since effective flags still remain and the value of the next flag is “0”, address 0×50000020 of the next command 9 is allocated to IP. Further, since the effective flag still remains and the value of the next flag is “1”, command 9 is displayed at address 0×50000020, and since the value of the next flag is “0”, no command is displayed and IP is incremented.

Since the processing for the number of the effective flags is completed, TP is assigned to address 0×2, and program control is returned to step 2001. Since TP=ETP is determined, the execution history retrieval processing is terminated.

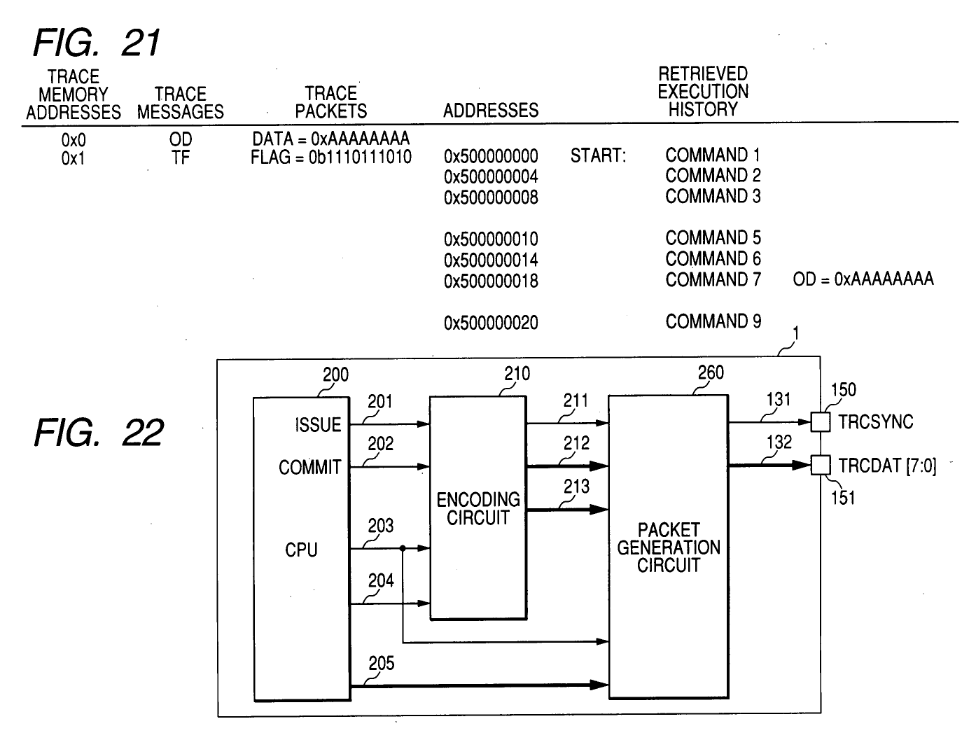

FIG. 21 is a diagram showing an execution history obtained through this processing. In FIG. 21, “trace memory addresses”, “trace messages”, “trace packets” “addresses” and a “retrieved execution history” are shown, and it is confirmed that the sample program shown in FIG. 17 could be retrieved.

As described above, since the operand detection signal 203 is masked by using the encoded data output mode signal 204, output of encoded data as trace data can be inhibited when operand information is generated. Thus, the increase of trace data due to generation of operand information can be suppressed.

### Third Embodiment

FIG. 22 is a block diagram showing the configuration of a processor according to a third embodiment of the present invention. In FIG. 22, a processor 1 includes: a CPU 200, an encoding circuit 210, a packet generation circuit 260, a trace state output terminal 150 and a trace data output terminal 151.

The CPU 200 outputs, to the encoding circuit 210, a command issue signal 201, a command execution condition establishing signal 202, an operand detection signal 203 and an encoded data output mode signal 204. The CPU 200 also outputs operand data 205 to the packet generation circuit 260.

When a command execution condition is established, the execution issue signal 201 and the command execution establishing signal 202 become “1”, and when the command execution condition is not established, the command issue signal 201 becomes “1”, and the command execution condition establishing signal 202 becomes “0”. When operand information is generated, the operand detection signal 203 becomes “1”.

The encoded data output mode signal 204 is a mode signal used to designate whether the operand detection signal 203 should be included in a condition for generating an encoded data output select signal 211. When the encoded data output mode signal 204 indicates “1”, the operand detection signal 203 should not be included in the condition for generating the encoded data output select signal 211.

The encoding circuit 210 receives the command issue signal 201, the command execution condition establishing signal 202, the operand detection signal 203 and the encoded data output mode signal 204, and outputs, to the packet generation circuit 260, the encoded data output select signal 211, encoded data 212 and a bit count value 213 of the encoded data 212. The details of the encoding circuit 210 are as previously described in the second embodiment.

The packet generation circuit 260 receives the encoded data output select signal 211, the encoded data 212, the bit count value 213 of the encoded data 212, the operand detection signal 203 and operand data 205, and outputs a trace packet output state signal 131 to the trace state output terminal 150, while outputting a trace packet 132 to the trace data output terminal 151.

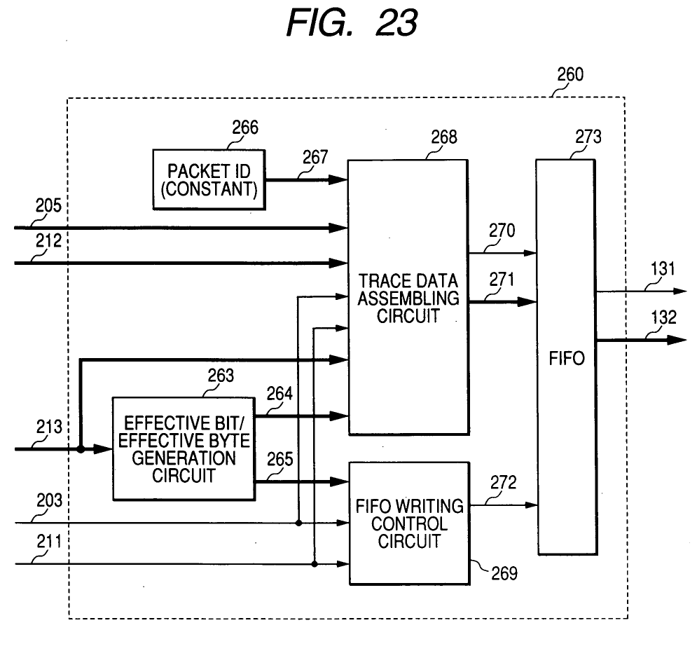

FIG. 23 is a block diagram showing the internal arrangement of the packet generation circuit 260. In FIG. 23, the packet generation circuit 260 includes: an effective bit count/byte count generation circuit 263, a packet ID storage circuit 266, a trace data assembling circuit 268, an FIFO writing control circuit 269 and an FIFO queue 273.

The effective bit count/byte count generation circuit 263 generates an effective bit count 264 in accordance with the least three significant bits of the bit count value 213, and generates an effective byte count 265 in accordance with the value equal to or greater than the least fourth significant bit of the bit count value 213. The packet ID storage circuit 266 stores a packet ID 267 that is a constant.

The trace data assembling circuit 268 receives the packet ID 267, the operand data 205, the encoded data 212, the effective bit count 264, the operand detection signal 203, the encoded data output select signal 211 and the bit count value 213. When the encoded data output select signal 211 indicates “1”, the trace data assembling circuit 268 generates a data string consisting of the packet ID 267, the effective bit count 264 and the encoded data 212, divides this data string into bytes, and outputs the data byte by byte as trace data 271.

Further, when the operand detection signal 203 indicates “1”, the trace data assembling circuit 268 generates a data string consisting of the packet ID 267, the operand data 205 and the bit count value 213, divides this data string into bytes, and outputs the data byte by byte as the trace data 271.

In addition, when outputting the first effective data of those output as the trace data 271, the trace data assembling circuit 268 also outputs a trace data output state signal 270 of “1”. Then, when the second and following trace data 271 are output, the trace data output state signal 270 is set to “”.

The FIFO writing control circuit 269 receives the effective byte count 265, the encoded data output select signal 211 and the operand detection signal 203, and generates a write enable signal 272 to be transmitted to the FIFO queue 273 that handles the trace data output state signal 270 and the trace data 271.

The FIFO queue 273 receives the trace data output state signal 270, the trace data 271 and the write enable signal 272, shifts data received in synchronization with a reference clock for trace output, and outputs a trace packet output state signal 231 and a trace packet 232 in the order in which they were input.

The packet IDs stored in the packet ID storage circuit 266 are shown in FIG. 5; and when the encoded data 212 are output as trace data, the format used for trace packets output by the FIFO queue 273 is shown in FIG. 6. The contents of the packet ID and the format were previously explained in the related example and in the first and second embodiments.

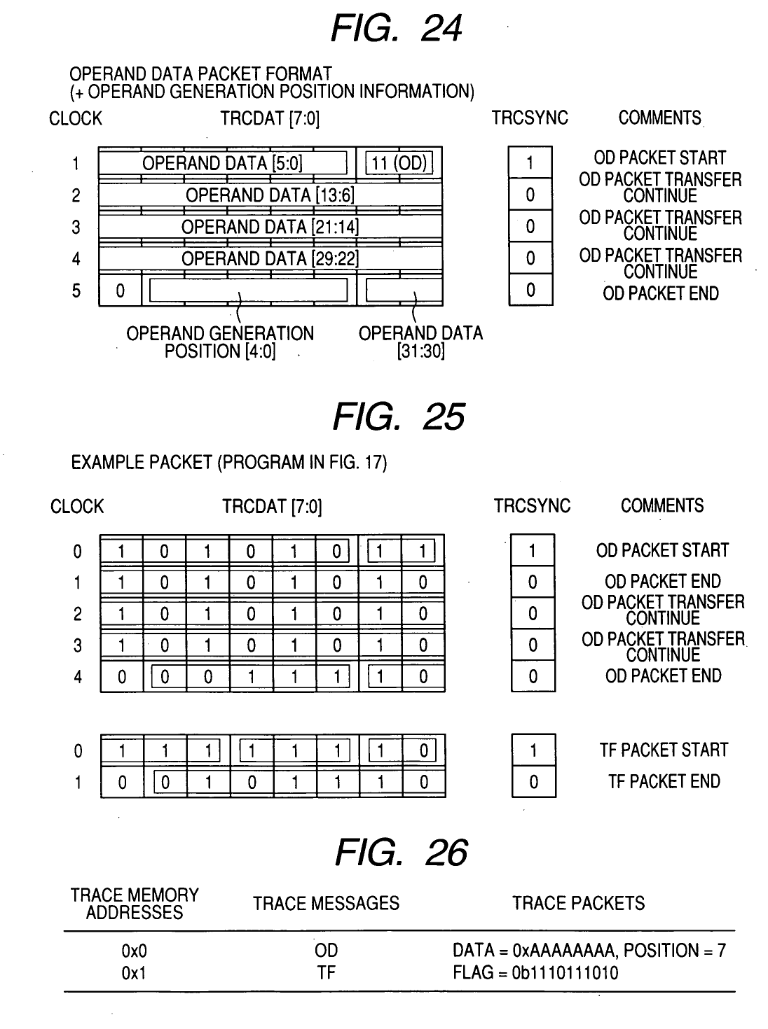

FIG. 24 is a diagram showing the format of a trace packet output by the FIFO queue 273 when the operant data 205 is output as trace data.

In FIG. 24, “clock” denotes a reference clock for trace output and TRCDAT[7:0] denotes the format of the trace packet 132, output to the trace data output terminal 151, and includes: Operand Data[31:0], indicating the value of the operand data 205; OD, indicating the value of a packet ID; and Operand generation position, indicating an operand generation position.

As shown in FIG. 24, in synchronization with “clock”, OD, the Operand Data[31:0] and the Operand generation position are sequentially output byte by byte as trace data.

While referring to FIGS. 25 to 28, an explanation will now be given for the state wherein the host computer 3 obtains trace data from the processor 1 having the above described arrangement, and retrieves an execution history. As in the second embodiment, the commands for the sample program in FIG. 17 are employed, while the comparison value used by the comparator 218 in FIG. 15 is “10”.

In FIG. 17, when commands are executed beginning at address 0×50000000, in synchronization with the operating frequency of the CPU 200, the command issue signal 201 is sequentially changed to “1111111111”, and at the same time, the command execution condition establishing signal 202 is changed to “1110111010”.

Further, when command 7 at address 0×50000018 is executed, the operand detection signal 203 is set to “1”; and “0×AAAAAAAA” is output as the operand data 205. In this case, the setup value of the encoded data output mode signal 204 is “1”.

Upon receiving these signals, the encoded data 212 output by the shift register 216 of the encoding circuit 210 is changed to “111111010”. Further, the bit count value 213 of the counter 215 is incremented to “0×a” while the value of the command issue signal 201 is regarded as a count enable signal. When the bit count value 213 reaches “0×7”, command 7 is executed, and the operand detection signal 203 is changed to “1”.

In this embodiment, since the operand detection signal 203=“1” is masked by the inverted signal of the encoded data output mode signal 204=“0”, and the encoded data output select signal 217 consonant with operand detection is set to “0”, the encoded data output select signal 211 at this time becomes “0”. And when the bit count value 213 of the counter 215 is incremented to “0×a”, the count match signal 220 is changed to “1” and the encoded data output select signal 211 becomes “1”.

When the operand detection signal 203 becomes “1”, the effective byte count 265 of “0b100” is output in accordance with a value equal to or greater than the fourth least significant bit of (bit count “0×20” of operand data+bit count “0×2” of a packet ID+bit count “0×5” of an operand generation position)

Upon receiving the effective byte count 265, the trace data assembling circuit 268 of the packet generation circuit 260 arranges, beginning with the least significant bit, packet ID=value “0b11” for OD, Operand Data=“0×AAAAAAAA”, Operand generation position=“0b00111” (the bit count value 213 when the operand detection signal 203 is “1”).

After the value of the operand detection signal 203 is changed to “1”, in synchronization with the reference clock for trace output, the FIFO writing control circuit 269 sets, to “1” five times (=the effective byte count 265+1), the write enable signal 272 to be transmitted to the FIFO queue 273.

In accordance with the write enable signal 272, data generated by the trace data assembling circuit 268 is output byte by byte to the FIFO queue 273 five times. Further, when the first byte of the data is output, the trace data output state signal 270 of “1” is output.

When the encoded data output select signal 211 is changed to “1”, the effective bit count 264 of “0b111” is output in accordance with the three least significant bits of (count value “0×a”+bit count “0×a” of NV+bit count “0×2” of a packet ID), and the effective byte count 265 of “0b1” is output in accordance with a value equal to or greater than the fourth least significant bit.

Upon receiving the effective bit count 264, the trace data assembling circuit 268 of the packet generation circuit 260 arranges, beginning with the least significant bit, packet ID=value “0b01” of TF, NV=value “0b111” of the effective bit 234 and Taken Flag=“0b1101101”.

After the value of the encoded data output select signal 211 is changed to “1”, in synchronization with the reference clock for trace output, the FIFO writing control circuit 269 sets, to “1” two times (=effective byte count 265+1), the write enable signal 272 to be transmitted to the FIFO queue 273.

In accordance with the write enable signal 272, data generated by the trace data assembling circuit 268 is output byte by byte to the FIFO queue 273 two times. When the first byte of the data is output, the trace data output state signal 270 of “1” is output.

The FIFO queue 273 receives the data and the trace data output state signal 270, and outputs the trace packet 132 and the trace packet output state signal 131. FIG. 25 is a diagram showing a trace packet when the sample program shown in FIG. 17 is executed.

The host computer 3 receives the packet shown in FIG. 25, and first obtains information packet ID=OD from TRCDAT[1:0] It then obtains operand data DATA=0×AAAAAAAA and operand generation position POSITION=7.

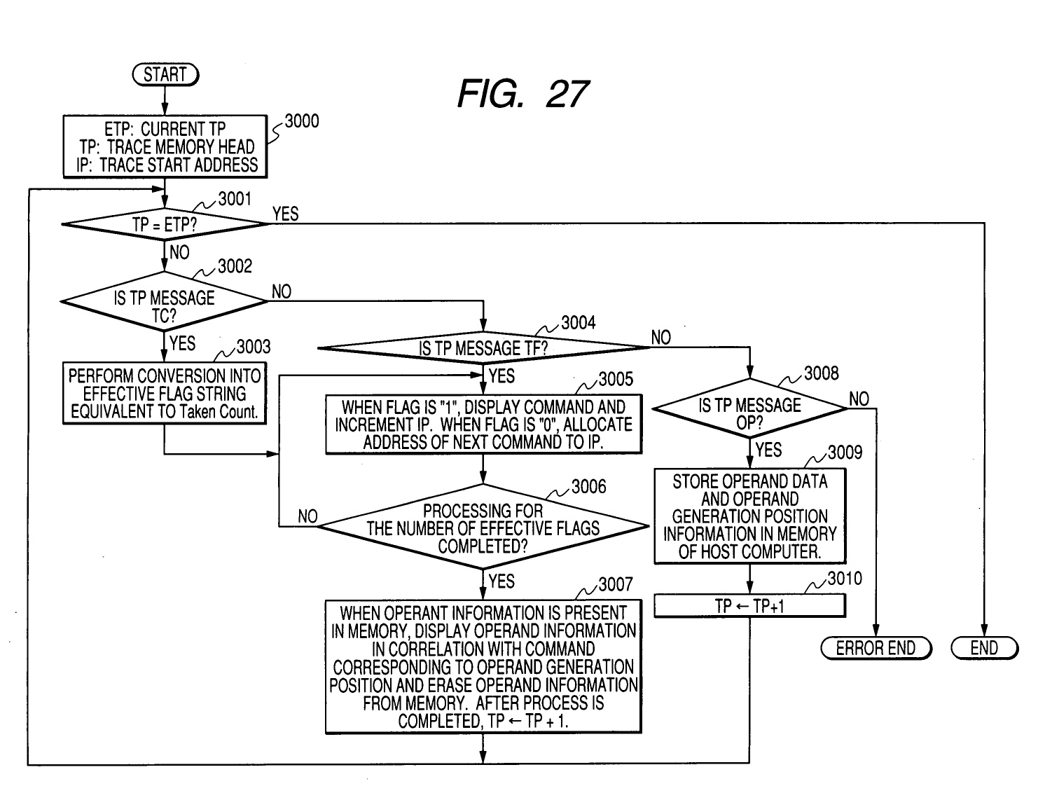

Then, packet ID=TF and NV=7 are respectively obtained from TRCDAT[1:0] and TRCDAT[4:2]. Since NV=7, encoded data FLAG=0b1110111010 is obtained. FIG. 26 is a diagram showing trace information that the host computer 3 has obtained from the processor 1 in this manner.

An explanation will now be given for the processing wherein the host computer 3 retrieves an execution history by employing the sample program in FIG. 17 and the trace information in FIG. 26. FIG. 27 is a flowchart showing the algorithm for the execution history retrieval processing performed by the host computer 3.

In FIG. 27, at step 3000, IP is assigned to address 0×50000000, TP is assigned to address 0×0, and ETP is assigned to address 0×2. Since TP#ETP, program control skips step 3001 and advances to step 3002, and since a trace message is OD, advances to steps 3008 and 3009. Then, information OD=0×AAAAAAAA and POSITION=7 is stored in the memory of the host computer 3, and TP is assigned to address 0×1. Program control thereafter returns to step 3001.

Since TP≠ETP, program control advances to step 3002, and since a trace message is TF, advances to steps 3004 and 3005. Since a flag has the value of “1”, command 1 is displayed at address 0×50000000, and IP is incremented to address 0×50000004.

Since effective flags still remain and the next flag has a value of “1”, command 2 is displayed at address 0×50000004, and IP is incremented to address 0×50000008. Similarly, command 3 is displayed at address 0×50000008, and since effective flags still remain and the next flag has a value of “0”, address 0×50000010 of the next command 5 is allocated to IP.

Since effective flags still remain and the next flag has a value of “1”, command 5 is displayed at address 0×50000010, and IP is incremented to address 0×50000014. Likewise, command 6 and command 7 are respectively displayed at addresses 0×50000014 and 0×50000018.

Since effective flags still remain and the next flag has a value of “0”, address 0×50000020 of the next command 9 is allocated to IP. Since an effective flag still remains and the next flag has a value of “1”, command 9 is displayed at address 0×50000020, and then, since the next flag has a value of “0”, no command is displayed, and IP is incremented.

Since the process for the number of effective flags is completed, operand data OD=0×AAAAAAAA stored in the memory of the host computer 3 is displayed in correlation with command 7, which corresponds to operand generation position POSITION=7, and this operand information is erased from the memory. Sequentially, TP is assigned to address “0×2”, and program control returns to step 3001. Then, since TP=ETP is determined, the execution history retrieval processing is terminated.

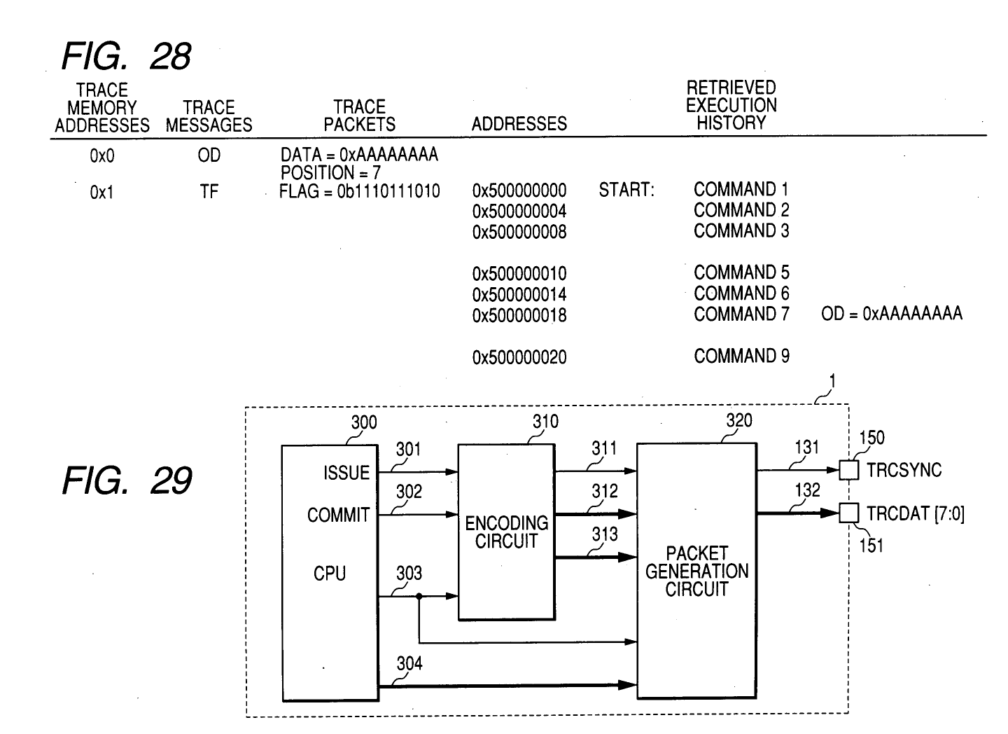

FIG. 28 is a diagram showing an execution history obtained through this processing. In FIG. 28, “trace memory addresses”, “trace messages”, “trace packets”, “addresses” and a “retrieved execution history” are shown, and it can be confirmed that the sample program shown in FIG. 17 has been retrieved.

As described above, when operand information is generated, the bit count value of the encoded flag is output together with the trace packet of operand data. Therefore, even in a case wherein the encoding circuit does not output encoded data as trace data at the time operand information is generated, information indicating by which command operand information was generated can be traced.

The processor and the development supporting apparatus according to this invention are useful as means for externally analyzing and evaluating the operation of the processor.

What is claimed is:

1. A processor comprising:
a statically scheduled command removal unit which removes a statically scheduled command upon receiving a command issue signal, a command execution condition establishing signal and an execution determination signal consonant with static scheduling;
an encoding unit which encodes an execution history for commands, except for the static scheduled command, upon receiving the command execution condition establishing signal and the command issue signal which are obtained by the static scheduled command removal unit; and
a data packet generator which generates a trace packet upon receiving encoded data obtained by the encoding unit.

2. The processor according to claim 1, wherein the static scheduled command is excluded from the command execution condition establishing signal and the command issue signal obtained by the static scheduled command removal unit.

3. A processor comprising:
an encoding unit which encodes an execution history for commands upon receiving a command issue signal, a command execution condition establishing signal, an operand detection signal and operand data;
a data packet generator which generates a trace packet upon receiving encoded data obtained by the encoding unit; and
a controller which immediately outputs an operand data packet and halts output of an execution flag packet according to claim 1 when the operand detection signal is generated.

4. A processor comprising:
an encoding unit which encodes an execution history for commands upon receiving a command issue signal, a command execution condition establishing signal, an operand detection signal and operand data;
a unit which detects an operand position in a source program; and
a data packet generator which receives encoded data obtained by the encoding unit and information concerning the operand position, and generates a trace packet that includes information concerning the operand position.

5. A development supporting apparatus comprising:
a computer that employs a trace packet generated by a processor according to claim 1, and that employs a source program, executed by the processor, to execute an execution history retrieval program that retrieves and displays an execution history for the processor; and
a unit for unconditionally displaying commands in the source program for which execution is determined by static scheduling, for correlating, with information in the trace packet, commands in the source program for which execution is not determined by static scheduling, for displaying commands when correlated information in the trace packet indicates an execution condition has been established, and for not displaying commands when correlated information in the trace packet indicates an execution condition has not been established.

6. A development supporting apparatus comprising:
a computer that employs a trace packet generated by a processor according to claim 3, and a source program, executed by the processor, to execute an execution history retrieval program that retrieves and displays an execution history for the processor.

7. A development supporting apparatus comprising:
a computer that employs a trace packet generated by a processor according to claim 4, and a source program, executed by the processor, to execute an execution history retrieval program that retrieves and displays an execution history for the processor.
